(19) United States
(12) Patent Application Publication
(10) Pub. No.: US 2020/0018962 A1
(43) Pub. Date: Jan. 16, 2020

(54) ADAPTIVE LENSES FOR NEAR-EYE DISPLAYS

(71) Applicant: Facebook Technologies, LLC, Menlo Park, CA (US)

(72) Inventors: Lu Lu, Kirkland, WA (US); Yijing Fu, Redmond, WA (US); Oleg Yaroshchuk, Redmond, WA (US); Kevin James MacKenzie, Sammamish, WA (US); Mengfei Wang, Seattle, WA (US); Alireza Moheghi, Kirkland, WA (US); John Cooke, Bothell, WA (US); Andrew John Ouderkirk, Redmond, WA (US)

(21) Appl. No.: 16/033,085

(22) Filed: Jul. 11, 2018

(51) Int. Cl. G02B 27/01; G02B 27/00; G02B 5/30; G06F 3/01; G02F 1/1335; G02F 1/137

(52) U.S. Cl. CPC G02B 27/0172; G02B 27/0176; G02B 27/0093; G02B 5/3025; G02B 5/3016; G02F 2001/133541; G06F 3/013; G02F 1/133528; G02F 1/13725; G02B 2027/0178; G06F 3/012

(57) ABSTRACT

A lens assembly includes two or more polarization-dependent lenses sensitive to either linear or circular polarization, and at least one switchable polarization converter. The switchable polarization converter is configured to rotate linearly polarized light or change the handedness of circularly polarized light when switched on. The lens assembly is configurable to project displayed images on two or more different image planes. For example, when the switchable polarization converter is switched off, the lens assembly projects a displayed image on a first image plane. When the switchable polarization converter is switched on, the lens assembly projects a displayed image on a second image plane different from the first image plane.

### BACKGROUND

An artificial reality system, such as a head-mounted display (HMD) or heads-up display (HUD) system, generally includes a near-eye display (e.g., a headset or a pair of glasses) configured to present content to a user via an electronic or optic display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

The near-eye display may include an optical system configured to form an image of a computer-generated image on an image plane. The optical system of the near-eye display may relay the image generated by an image source to create virtual images that appear to be away from the image source and further than just a few centimeters away from the eyes of the user. The optical system may magnify the image source to make the image appear larger than the actual size of the image source. Many near-eye display systems only have one fixed image plane at about, for example, 2 meters or 3 meters away from user's eyes. An image plane at a fixed distance away from the user's eyes may be appropriate for some content, but may not be appropriate for some other content. In many cases, a single image plane may cause ocular stress and eye discomfort, for example, in situations where a closer visual image may provide a better user experience.

### SUMMARY

This disclosure relates generally to techniques for displaying images at two or more image planes in a near-eye display. In some embodiments, a near-eye display may include a display device configured to generate a first image and a second image, and a first assembly of polarization sensitive lenses. The first assembly of polarization sensitive lenses may include a first lens having different optical powers for light in a first polarization state and light in a second polarization state, a second lens having different optical powers for light in the first polarization state and light in the second polarization state, and a switchable polarization converter configured to, after being turned on, convert light in the first polarization state to light in the second polarization state. The first assembly of polarization sensitive lenses may be configured to form a virtual image of the first image on a first image plane of the near-eye display with the switchable polarization converter turned off, or form a virtual image of the second image on a second image plane of the near-eye display with the switchable polarization converter turned on, where the second image plane and the first image plane are at different distances from the near-eye display. In some embodiments, the first lens and the second lens are passive or active liquid crystal lenses. In some embodiments, the first assembly may further be configured to form a virtual image of a third image generated by the display device on a third image plane of the near-eye display.

In some embodiments of the near-eye display, the first polarization state may be a first linear polarization state, and the second polarization state may be a second linear polarization state with a polarization direction orthogonal to a polarization direction of the first linear polarization state. The first lens may have a first non-zero optical power for light in the first linear polarization state and a zero optical power for light in the second linear polarization state, and the second lens may have a second non-zero optical power for light in the second linear polarization state and a zero optical power for light in the first linear polarization state. In some embodiments, the switchable polarization converter may include a switchable liquid crystal half-wave plate. In some embodiments, the switchable polarization converter may include a switchable liquid crystal polarization rotator including a 90° twisted nematic liquid crystal cell.

In some embodiments, the switchable polarization converter may be positioned between the display device and the first lens, the first image plane may correspond to the first non-zero optical power, and the second image plane may correspond to the second non-zero optical power. In some embodiments, the switchable polarization converter may be positioned between the first lens and the second lens, the first image plane may correspond to the first non-zero optical power, and the second image plane may correspond to a combination of the first non-zero optical power and the second non-zero optical power.

In some embodiments of the near-eye display, the first polarization state may be a first circular polarization state, and the second polarization state may be a second circular polarization state having a handedness opposite to a handedness of the first circular polarization state. The first lens may have an optical power X for light in the first circular polarization state and an optical power −X for light in the second circular polarization state. The second lens may have an optical power Y for light in the first circular polarization state and an optical power −Y for light in the second circular polarization state. The switchable polarization converter may include a switchable half-wave plate. In some embodiments, the switchable polarization converter may be positioned between the first lens and the second lens.

In some embodiments of the near-eye display, the first assembly may further include a polarizer configured to polarize light from the first image and the second image into light in the first polarization state. In some embodiments, the near-eye display may further include a second assembly of polarization sensitive lenses, where the second assembly has opposite optical power compared with the first assembly. In some embodiments, the second assembly may include a third polarization sensitive lens having an optical power opposite to an optical power of the first lens for light in the first polarization state, a fourth polarization sensitive lens having an optical power opposite to an optical power of the second lens for light in the second polarization state, and a second switchable polarization converter configure to convert light in the first polarization state to light in the second polarization state after being turned on.

In some embodiments, the near-eye display may further include a dimming device switchable between a first state and a second state, where the dimming device may be configured to transmit ambient light in the first state and attenuate the ambient light in the second state. In some embodiments, the dimming device may include a guest-host liquid crystal light dimming element, a polymer-dispersed liquid crystal light dimming element, or a polymer-stabilized cholesteric texture liquid crystal light dimming element.

In some embodiments, a lens assembly for near-eye display may include a first polarization-dependent lens having a first non-zero optical power for light in a first polarization state, a second polarization-dependent lens having a second non-zero optical power for light in a second polarization state that is different from the first polarization state, and a polarization converter switchable between a first state and a second state. The polarization converter may be configured to transmit light in the first polarization state or convert light in the first polarization state to light in the second polarization state.

In some embodiments of the lens assembly for near-eye display, the polarization converter may include a 90° twisted nematic liquid crystal cell, and the polarization converter may be switchable between the first state and the second state based on a voltage signal applied to the 90° twisted nematic liquid crystal cell. In some embodiments, the first polarization-dependent lens and the second polarization-dependent lens may include a passive or active liquid crystal lens. In some embodiments, the liquid crystal lens may include a plane-convex liquid crystal lens, a flat liquid crystal lens including tilted liquid crystal molecules where the liquid crystal molecules may be tilted at different angles at different areas of the flat liquid crystal lens, a diffractive liquid crystal lens including a plurality of zones where liquid crystal molecules in the plurality of zones may be tilted at different angles, or a geometric-phase liquid crystal lens.

In some embodiments of the lens assembly for near-eye display, the first polarization-dependent lens and the second polarization-dependent lens may be positioned on a same side of the polarization converter or on different sides of the polarization converter. In some embodiments, the first polarization state and the second polarization state may include linear polarizations at orthogonal polarization directions or left-handed circular polarization and right-handed circular polarization. In some embodiments, the lens assembly may further include a polarizer configured to polarize incident light into light in the first polarization state, where the first polarization-dependent lens, the second polarization-dependent lens, and the polarization converter may be positioned on a same side of the polarizer.

According to certain embodiments, a method of adaptively displaying images on two or more image planes using a lens assembly is disclosed. The method may include polarizing light from a first image into light in a first polarization state, and forming a virtual image of the first image on a first image plane using a first lens and a second lens of the lens assembly. The first lens may have different optical powers for light in the first polarization state and light in a second polarization state orthogonal to the first polarization state, and the second lens may have different optical powers for light in the first polarization state and light in the second polarization state. The method may further include polarizing light from a second image into light in the first polarization state, and forming a virtual image of the second image on a second image plane using the first lens and the second lens, where the second image plane and the first image plane are at different distances from the lens assembly. Forming the virtual image of the second image on the second image plane may include converting, using a switchable polarization converter in the lens assembly, the light in the first polarization state from the second image into light in the second polarization state.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example artificial reality system environment including a near-eye display according to certain embodiments.

FIG. 2 is a perspective view of an example near-eye display in the form of a head-mounted display (HMD) device for implementing some of the examples disclosed herein.

FIG. 3 is a perspective view of a simplified example near-eye display in the form of a pair of glasses for implementing some of the examples disclosed herein.

FIG. 4 illustrates an example optical see-through augmented reality system using a waveguide display according to certain embodiments.

FIG. 5 is a cross-sectional view of an example near-eye display according to certain embodiments.

FIG. 6 illustrates an example optical system for a near-eye display device according to certain embodiments.

FIG. 7 illustrates an example optical system for a near-eye display device according to certain embodiments.

FIG. 8A illustrates the coupling between the focal distance and vergence distance in a natural environment.

FIG. 8B illustrates the conflict between the focal distance and vergence distance in a near-eye display environment.

FIG. 9 illustrates an example liquid crystal lens stack for displaying images on two discrete image planes according to certain embodiments.

FIG. 10 is an exploded view of an example near-eye display device including an adaptive liquid crystal lens stack according to certain embodiments.

FIG. 11A illustrates an example liquid crystal device having a zero optical power and including a liquid crystal cell with uniform alignment.

FIG. 11B illustrates an example liquid crystal device with a negative optical power and including a liquid crystal cell with non-uniform alignment acting as a lens sensitive to linearly polarized light.

FIG. 11C illustrates an example liquid crystal device with a positive optical power and including a liquid crystal cell with non-uniform alignment acting as a lens sensitive to linearly polarized light.

FIG. 12 illustrates an example chromatic polarization converter based on a half-wave plate, which rotates linearly polarized light by an angle 20 (where θ is the angle between the polarization direction of the incident light and the optical axis of the half-wave plate) or changes the handedness of circularly polarized light.

FIGS. 13A-13C illustrate an example achromatic liquid crystal polarization rotator based on a twisted nematic liquid crystal cell according to certain embodiments. FIG. 13A illustrates the achromatic liquid crystal polarization rotator in an “ON” state (i.e., the liquid crystal cell is in the field-off state) where the achromatic liquid crystal polarization rotator is configured to change the polarization state of incident light. FIG. 13B illustrates the achromatic liquid crystal polarization rotator in an “OFF” state (i.e., the liquid crystal cell is in the field-on state) where the achromatic liquid crystal polarization rotator would not change the polarization state of incident light. FIG. 13C illustrates the rotation of linearly polarized light by the achromatic liquid crystal polarization rotator in the “ON” state. In the example, the achromatic liquid crystal polarization rotator is a 90° TN liquid crystal cell in which light propagates in the Mauguin regime.

FIGS. 14A-14D illustrate an example near-eye display device having a switchable optical power. FIG. 14A illustrates the near-eye display device having a zero optical power when a switchable polarization rotator is in an “ON” state to change the polarization state of incident light, where the near-eye display device includes a twisted nematic liquid crystal cell-based polarization rotator and a linear polarization-dependent LC lens. FIG. 14B illustrates a linear polarization-dependent liquid crystal lens having a zero optical power for light in a first polarization state. FIG. 14C illustrates the near-eye display device having a non-zero optical power when the switchable polarization rotator is in an “OFF” state and thus would not change the polarization state of incident light. FIG. 14D illustrates a linear polarization-dependent liquid crystal lens having a non-zero optical power for light in a second polarization state.

FIGS. 15A and 15B illustrate an example liquid crystal device including lenses sensitive to circularly polarized light according to certain embodiments.

FIG. 16A illustrates an example switchable polymer-dispersed liquid crystal light dimming element in an “OFF” state where incident light is blocked or significantly attenuated.

FIG. 16B illustrates an example switchable polymer-dispersed liquid crystal light dimming device in an “ON” state where the polymer-dispersed liquid crystal light dimming device is substantially transparent.

FIG. 17A illustrates an example switchable guest-host liquid crystal light dimming device in an “OFF” state.

FIG. 17B illustrates an example switchable guest-host liquid crystal light dimming device in an “ON” state.

FIG. 18A illustrates an example switchable polymer-stabilized cholesteric texture liquid crystal light dimming device in an “OFF” state.

FIG. 18B illustrates an example switchable polymer-stabilized cholesteric texture liquid crystal light dimming device in an “ON” state.

FIG. 19 is a simplified flow chart illustrating an example method of adaptively displaying images on two or more image planes according to certain embodiments.

FIG. 20 is a simplified block diagram of an example electronic system of an example near-eye display according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques disclosed herein relate generally to displaying images on two or more image planes in a near-eye display for improved user experience. In near-eye displays, displaying images on a single fixed image plane may cause ocular stress or discomfort (e.g., due to the vergence-accommodation conflict or distorted depth perception), which is one of the reasons for virtual reality (VR) sickness. According to some embodiments, a lens assembly including two or more polarization-dependent liquid crystal (LC) lenses sensitive to either linear or circular polarization and having same or different optical powers can be used to project a displayed image on one of multiple image planes that are at different distances from the user's eyes. In some embodiments, the lens assembly may also include a polarizer, such as a linear polarizer or circular polarizer, and a polarization converter which may rotate linearly polarized light or change the handedness of circularly polarized light.

In some embodiments, the LC lenses may be sensitive to linearly polarized light. A first LC lens may have a first non-zero optical power for light in a first linear polarization state, and a second LC lens may have a zero optical power for light in the first linear polarization state and a second non-zero optical power for light in a second linear polarization state that may be orthogonal to the first linear polarization state. For example, the alignment direction of the first LC lens may be θ, while the alignment direction of the second LC lens may be θ+90°. The lens assembly may include a switchable polarization rotator, which, when turned on (or off), may convert light in the first linear polarization state to light in the second linear polarization state, or vice versa, such as rotating a linearly polarized light by, for example, 90°. The switchable polarization rotator may be turned on or off by applying different electrical fields on the switchable polarization rotator using signals of different voltage levels or polarities.

In some embodiments, the switchable polarization rotator may be positioned after the polarizer and in front of the first linear polarization sensitive LC lens and the second linear polarization sensitive LC lens. During operations of the lens assembly, light from a displayed image may be polarized by the polarizer to the first linear polarization state. When the switchable polarization rotator is turned off (e.g., no polarization rotation), the first LC lens may provide the first non-zero optical power (e.g., A) for light in the first linear polarization state, which may correspond to a first virtual image distance in front of the user's eyes. The second LC lens may provide a zero optical power for light in the first linear polarization state, and thus would not change the position of the image plane. When the switchable polarization rotator is turned on, the polarized light in the first linear polarization state may be changed to polarized light in the orthogonal second linear polarization state. The first LC lens may provide a zero optical power for light in the second linear polarization state, while the second LC lens may provide a second non-zero optical power (e.g., B) for light in the second linear polarization state, which may correspond to a second virtual image distance in front of the user's eyes. As such, by turning on/off the switchable polarization rotator, the displayed image may be projected on an image plane at the first or second virtual image distance.

In some embodiments, the switchable polarization rotator may be positioned between the first linear polarization sensitive LC lens and the second linear polarization sensitive LC lens. During operations of the lens assembly, light from a displayed image may be linearly polarized by the polarizer to the first linear polarization state. The first LC lens may provide the first non-zero optical power (e.g., A) for light in the first linear polarization state, which may correspond to a first virtual image distance in front of the user's eyes. When the switchable polarization rotator is turned off (e.g., no polarization rotation), the polarized light may remain in the first linear polarization state after passing through the first LC lens and the switchable polarization rotator. The second LC lens may have a zero optical power for light in the first linear polarization state, and thus would not change the position of the image plane. When the switchable polarization rotator is turned on, the polarized light in the first linear polarization state may be changed to linearly polarized light in the orthogonal second linearly polarization state after passing through the first LC lens and the switchable polarization rotator. The second LC lens may provide the second non-zero optical power (e.g., B) for light in the second linear polarization state. Thus, when the switchable polarization rotator is turned on, the total optical power of the lens assembly is the combination of the first optical power and the second optical power, and may correspond to a second virtual image distance in front of the user's eyes. As such, by turning on/off the switchable polarization rotator, the displayed image may be projected on an image plane at the first or second virtual image distance.

In some embodiments, the LC lenses may be sensitive to circularly polarized light. A switchable polarization converter may be positioned between a first circular polarization sensitive LC lens and the second circular polarization sensitive LC lens. The first circular polarization sensitive LC lens may have an optical power X for circularly polarized light in one polarization handedness (e.g., left-handed) and −X for circularly polarized light in an orthogonal polarization handedness (e.g., right-handed). Similarly, the second switchable polarization converter may have an optical power Y for circularly polarized light in one polarization handedness (e.g., left-handed) and −Y for circularly polarized light in an orthogonal polarization handedness (e.g., right-handed). Circularly polarized light in one handedness (e.g., left-handed) may pass through the first circular polarization sensitive LC lens and change its handedness (e.g., to right-handed), the switchable polarization converter may (e.g., in the “ON” state) or may not (e.g., in the “OFF” state) change the handedness of the circularly polarized light passing through it, and second circular polarization sensitive LC lens may have a positive or negative optical power for the circularly polarized light from the switchable polarization converter (depending on the handedness of the circularly polarized light). Thus, when the switchable polarization converter is in the “ON” state (with polarization conversion), the two circular polarization sensitive LC lenses may receive circularly polarized light in the same handedness, and the total optical power of the lens assembly may be X+Y. When the switchable polarization converter is in the “OFF” state (no polarization conversion), the two circular polarization sensitive LC lenses may receive circularly polarized light in different handednesses, and thus the total optical power of the lens assembly may be X−Y.

In this way, the image may be displayed at two or more virtual image distances based on the content vergence position (e.g., intended distances of objects in the image), which may thus reduce the vergence-accommodation conflict and provide a comfort viewing experience for the eyes when viewing content at different vergence positions.

In some implementations, in order to use the same near-eye display device in the see-through mode (e.g., to view real world image in front of the near-eye display device), the near-eye display may also include a second lens assembly having polarization-dependent LC lenses with optical powers opposite to the optical powers of the LC lenses in the first lens assembly. For example, if the first lens assembly includes two LC lenses with optical powers of about A and B, respectively, the second lens assembly may include two LC lenses with optical powers of about −A and −B, respectively. Thus, for light in each of the first and second polarization states, the total optical power of the first lens assembly and the second lens assembly may be approximately 0, such as less than about ±0.25 diopter. As such, the user may view the ambient environment through the near-eye display device as if the two lens assemblies do not exist.

In some implementations, the near-eye display may also include an additional adaptive dimming element. The adaptive dimming element may include an LC material layer that can be tuned by applying an electrical field to change an orientation of the LC molecules, and thus changing the transmission rate of the adaptive dimming element for ambient light.

In some embodiments, the near-eye display may further include a photovoltaic material layer that can absorb invisible light (e.g., infrared and/or ultra-violet light) and convert the invisible light to electrical power to provide power to, for example, the switchable polarization converter and/or the adaptive dimming element.

As used herein, the term “polarization converter” may refer to a polarization rotator for rotating the polarization direction of a linearly polarized light beam or a polarization switch (or converter) for changing the handedness of a circularly polarized light beam. For example, a polarization converter may convert (e.g., rotate) a linearly polarized light beam with a polarization direction θ to a linearly polarized light beam with a polarization direction θ+90°. Another polarization converter may convert a left-handed circularly polarized light beam to a right-handed circularly polarized light beam, and vice versa. The polarization converter may include, for example, a wave plate or twisted nematic (TN) LC cell. The polarization converter may be chromatic (e.g., a wave plate) or achromatic (e.g., a TN LC cell operating in Mauguin regime). In some embodiments, the polarization converter may be switchable. For example, a LC-based wave plate or a TN LC cell-based polarization rotator may be switchable by applying a voltage signal across it. In the “ON” state, a switchable polarization converter may change the polarization state of incident light (e.g., rotate the polarization direction of linearly polarized light or change the handedness of circularly polarized light). In the “OFF” state, a switchable polarization converter may not change the polarization state of incident light.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

### I. Near-Eye Display

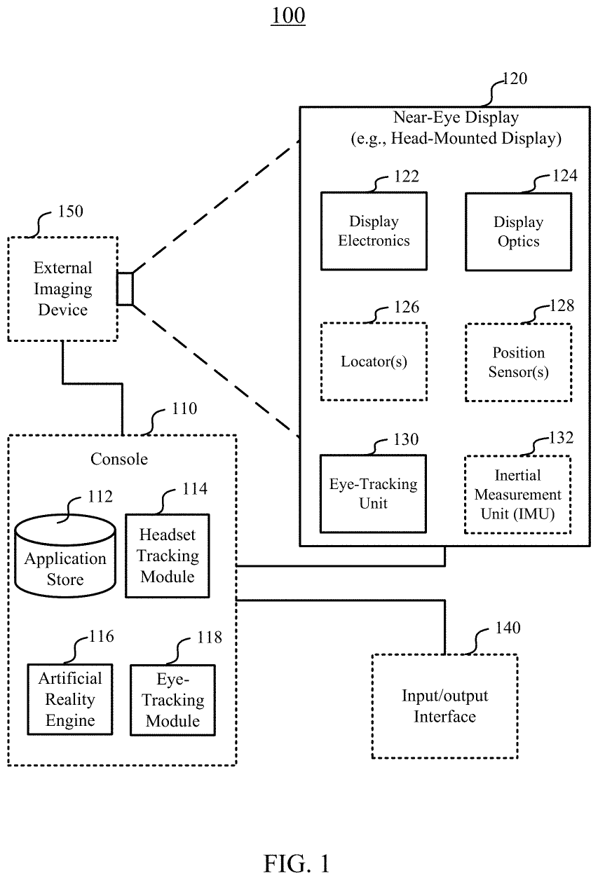

FIG. 1 is a simplified block diagram of an example artificial reality system environment 100 including a near-eye display 120 in accordance with certain embodiments. Artificial reality system environment 100 shown in FIG. 1 may include near-eye display 120, an optional external imaging device 150, and an optional input/output interface 140 that may each be coupled to an optional console 110. While FIG. 1 shows example artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

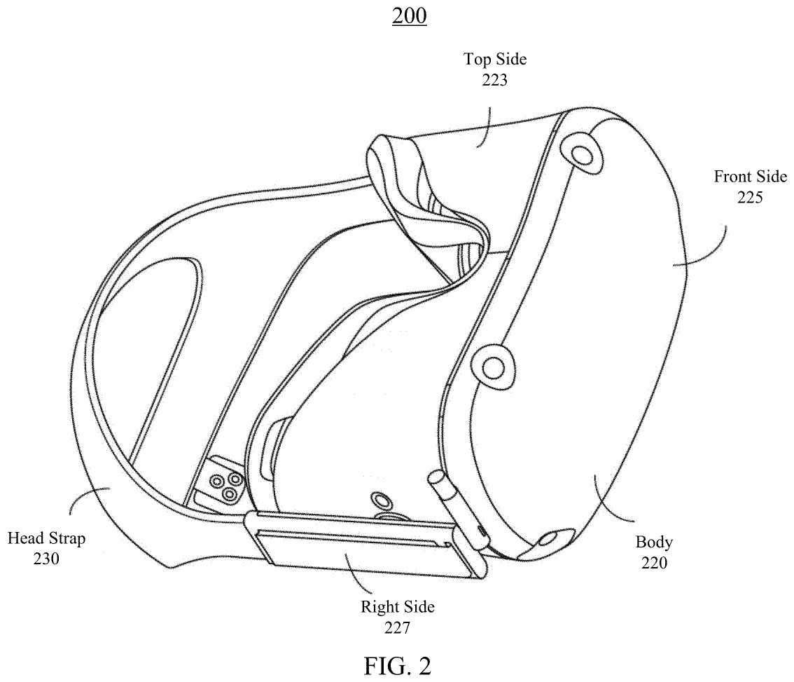

Near-eye display 120 may be a head-mounted display that presents content to a user. Examples of content presented by near-eye display 120 include one or more of images, videos, audios, or some combination thereof. In some embodiments, audios may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form factor, including a pair of glasses. Some embodiments of near-eye display 120 are further described below with respect to FIGS. 2, 3, and 20. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of these elements or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, a micro light emitting diode (mLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereo effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124.

Display optics 124 may also be designed to correct one or more types of optical errors, such as two-dimensional optical errors, three-dimensional optical errors, or a combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light emitting diode (LED), a corner cube reflector, a reflective marker, a type of light source that contrasts with an environment in which near-eye display 120 operates, or some combinations thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may generate slow calibration data based on calibration parameters received from console 110. Slow calibration data may include one or more images showing observed positions of locators 126 that are detectable by external imaging device 150. External imaging device 150 may include one or more cameras, one or more video cameras, any other device capable of capturing images including one or more of locators 126, or some combinations thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or some combinations thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or some combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or some combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or some combination thereof, to predict a future location of near-eye display 120. Headset tracking module 114 may provide the estimated or predicted future position of near-eye display 120 to artificial reality engine 116.

Headset tracking module 114 may calibrate the artificial reality system environment 100 using one or more calibration parameters, and may adjust one or more calibration parameters to reduce errors in determining the position of near-eye display 120. For example, headset tracking module 114 may adjust the focus of external imaging device 150 to obtain a more accurate position for observed locators on near-eye display 120. Moreover, calibration performed by headset tracking module 114 may also account for information received from IMU 132. Additionally, if tracking of near-eye display 120 is lost (e.g., external imaging device 150 loses line of sight of at least a threshold number of locators 126), headset tracking module 114 may re-calibrate some or all of the calibration parameters.

Artificial reality engine 116 may execute applications within artificial reality system environment 100 and receive position information of near-eye display 120, acceleration information of near-eye display 120, velocity information of near-eye display 120, predicted future positions of near-eye display 120, or some combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

In some embodiments, eye-tracking module 118 may store a mapping between images captured by eye-tracking unit 130 and eye positions to determine a reference eye position from an image captured by eye-tracking unit 130. Alternatively or additionally, eye-tracking module 118 may determine an updated eye position relative to a reference eye position by comparing an image from which the reference eye position is determined to an image from which the updated eye position is to be determined. Eye-tracking module 118 may determine eye position using measurements from different imaging devices or other sensors. For example, eye-tracking module 118 may use measurements from a slow eye-tracking system to determine a reference eye position, and then determine updated positions relative to the reference eye position from a fast eye-tracking system until a next reference eye position is determined based on measurements from the slow eye-tracking system.

Eye-tracking module 118 may also determine eye calibration parameters to improve precision and accuracy of eye tracking. Eye calibration parameters may include parameters that may change whenever a user dons or adjusts near-eye display 120. Example eye calibration parameters may include an estimated distance between a component of eye-tracking unit 130 and one or more parts of the eye, such as the eye's center, pupil, cornea boundary, or a point on the surface of the eye. Other example eye calibration parameters may be specific to a particular user and may include an estimated average eye radius, an average corneal radius, an average sclera radius, a map of features on the eye surface, and an estimated eye surface contour. In embodiments where light from the outside of near-eye display 120 may reach the eye (as in some augmented reality applications), the calibration parameters may include correction factors for intensity and color balance due to variations in light from the outside of near-eye display 120. Eye-tracking module 118 may use eye calibration parameters to determine whether the measurements captured by eye-tracking unit 130 would allow eye-tracking module 118 to determine an accurate eye position (also referred to herein as “valid measurements”). Invalid measurements, from which eye-tracking module 118 may not be able to determine an accurate eye position, may be caused by the user blinking, adjusting the headset, or removing the headset, and/or may be caused by near-eye display 120 experiencing greater than a threshold change in illumination due to external light. In some embodiments, at least some of the functions of eye-tracking module 118 may be performed by eye-tracking unit 130.

FIG. 2 is a perspective view of an example near-eye display in the form of a head-mounted display (HMD) device 200 for implementing some of the examples disclosed herein. HMD device 200 may be a part of, e.g., a virtual reality (VR) system, an augmented reality (AR) system, a mixed reality (MR) system, or some combinations thereof. HMD device 200 may include a body 220 and a head strap 230. FIG. 2 shows a top side 223, a front side 225, and a right side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temples tips as shown in, for example, FIG. 2, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audios, or some combinations thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, a liquid crystal display (LCD), an organic light emitting diode (OLED) display, an inorganic light emitting diode (ILED) display, a micro light emitting diode (mLED) display, an active-matrix organic light emitting diode (AMOLED) display, a transparent organic light emitting diode (TOLED) display, some other display, or some combinations thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or some combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

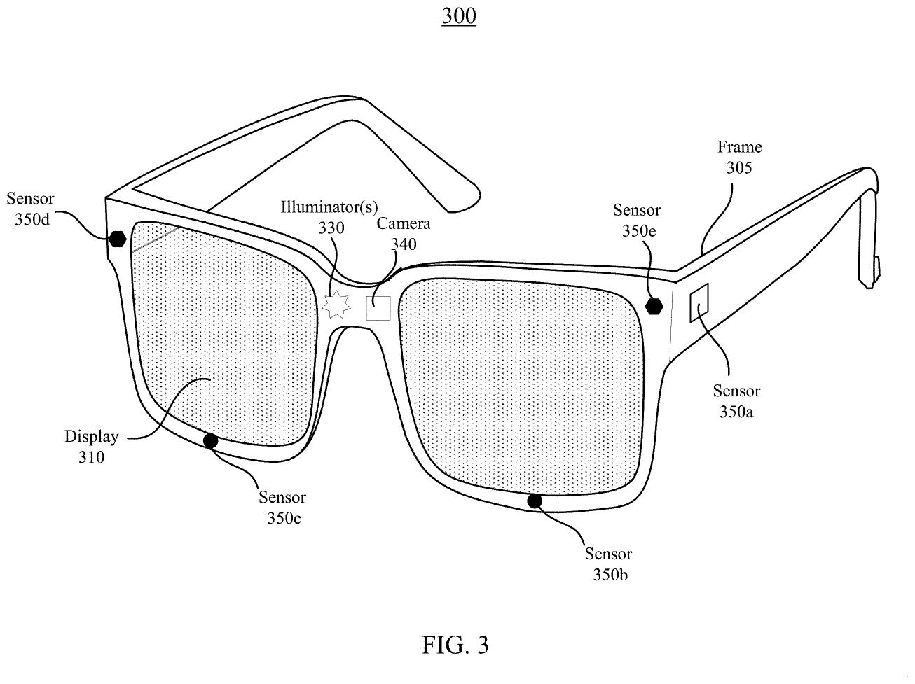

FIG. 3 is a perspective view of a simplified example near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light pattern onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

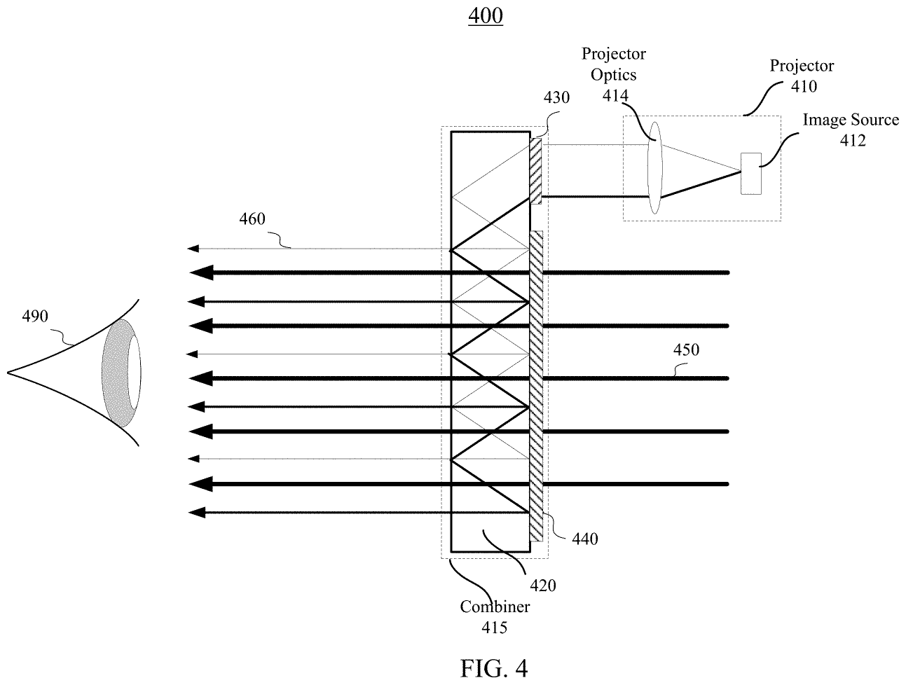

FIG. 4 illustrates an example optical see-through augmented reality system 400 using a waveguide display according to certain embodiments. Augmented reality system 400 may include a projector 410 and a combiner 415. Projector 410 may include a light source or image source 412 and projector optics 414. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, and/or a light emitting diode. In some embodiments, image source 412 may include a plurality of light sources each emitting a monochromatic image light corresponding to a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical elements (DOE) (e.g., a surface-relief grating), or a refractive coupler (e.g., a wedge or a prism). Input coupler 430 may have a coupling efficiency of greater than 30%, 50%, 75%, 90%, or higher for visible light. As used herein, visible light may refer to light with a wavelength between about 380 nm to about 750 nm. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more.

Substrate 420 may be transparent to visible light. A material may be “transparent” to a light beam if the light beam can pass through the material with a high transmission rate, such as larger than 50%, 40%, 75%, 80%, 90%, 95%, or higher, where a small portion of the light beam (e.g., less than 50%, 40%, 25%, 20%, 10%, 5%, or less) may be scattered, reflected, or absorbed by the material. The transmission rate (i.e., transmissivity) may be represented by either a photopically weighted or an unweighted average transmission rate over a range of wavelengths, or the lowest transmission rate over a range of wavelengths, such as the visible wavelength range.

Substrate 420 may include or may be coupled to a plurality of output couplers 440 configured to extract at least a portion of the light guided by and propagating within substrate 420 from substrate 420, and direct extracted light 460 to an eye 490 of the user of augmented reality system 400. As input coupler 430, output couplers 440 may include grating couplers (e.g., volume holographic gratings or surface-relief gratings), other DOEs, prisms, etc. Output couplers 440 may have different coupling (e.g., diffraction) efficiencies at different locations. Substrate 420 may also allow light 450 from environment in front of combiner 415 to pass through with little or no loss. Output couplers 440 may also allow light 450 to pass through with little loss. For example, in some implementations, output couplers 440 may have a low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 to certain desired directions (i.e., diffraction angles) with little loss. As a result, the user may be able to view combined images of the environment in front of combiner 415 and virtual objects projected by projector 410.

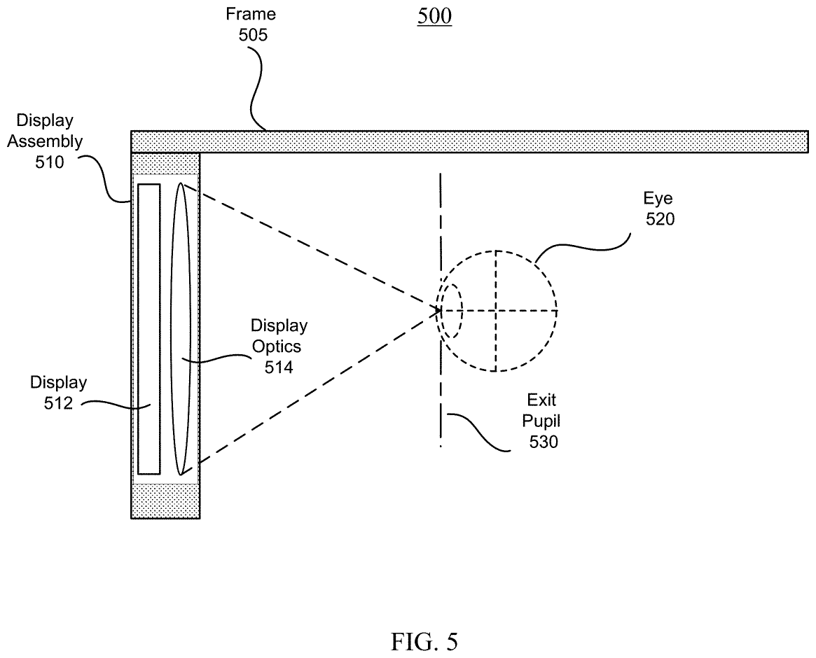

FIG. 5 is a cross-sectional view of an example near-eye display 500 according to certain embodiments. Near-eye display 500 may include at least one display assembly 510. Display assembly 510 may be configured to direct image light (i.e., display light) to an eyebox located at exit pupil 530 and to user's eye 520. It is noted that, even though FIG. 5 and other figures in the present disclosure show an eye of a user of a near-eye display for illustration purposes, the eye of the user is not a part of the corresponding near-eye display.

As HMD device 200 and near-eye display 300, near-eye display 500 may include a frame 505 and a display assembly 510 that includes a display 512 and/or display optics 514 coupled to or embedded in frame 505. As described above, display 512 may display images to the user electrically (e.g., using LCD) or optically (e.g., using a waveguide display and optical couplers) according to data received from a console, such as console 110. Display 512 may include sub-pixels to emit light of a predominant color, such as red, green, blue, white, or yellow. In some embodiments, display assembly 510 may include a stack of one or more waveguide displays including, but not restricted to, a stacked waveguide display, a varifocal waveguide display, etc. The stacked waveguide display is a polychromatic display (e.g., a red-green-blue (RGB) display) created by stacking waveguide displays whose respective monochromatic sources are of different colors. The stacked waveguide display may also be a polychromatic display that can be projected on multiple planes (e.g. multi-planar colored display). In some configurations, the stacked waveguide display may be a monochromatic display that can be projected on multiple planes (e.g. multi-planar monochromatic display). The varifocal waveguide display is a display that can adjust a focal position of image light emitted from the waveguide display. In alternate embodiments, display assembly 510 may include the stacked waveguide display and the varifocal waveguide display.

Display optics 514 may be similar to display optics 124 and may display image content optically (e.g., using optical waveguides and optical couplers), correct optical errors associated with the image light, combine images of virtual objects and real objects, and present the corrected image light to exit pupil 530 of near-eye display 500, where the user's eye 520 may be located at. Display optics 514 may also relay the image to create virtual images that appear to be away from the image source and further than just a few centimeters away from the eyes of the user. For example, display optics 514 may collimate the image source to create a virtual image that may appear to be far away and convert spatial information of the displayed virtual objects into angular information. Display optics 514 may also magnify the image source to make the image appear larger than the actual size of the image source. More detail of the display optics is described below.

### II. Display Optics

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include an internal aperture and some forms of projection optics that magnify an intermediary image and relay it to the exit pupil. The more complex optical system of the pupil-forming HMDs may allow for a larger number of optical elements in the path from the image source to the exit-pupil, which may be used to correct optical aberrations and generate focal cues, and may provide design freedom for packaging the HMD. For example, a number of reflectors (e.g., mirrors) may be inserted in the optical path so that the optical system may be folded or wrapped around to fit in a compact HMD.

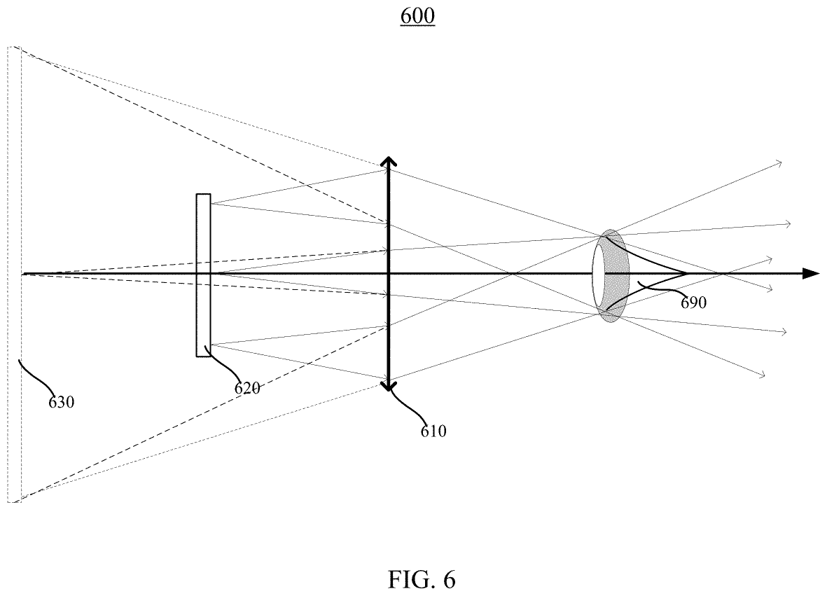

FIG. 6 illustrates an example optical system 600 with a non-pupil forming configuration for a near-eye display device according to certain embodiments. Optical system 600 may include projector optics 610 and an image source 620. Projector optics 610 may function as a magnifier. FIG. 6 shows that image source 620 is in front of projector optics 610. In some other embodiments, image source 620 may be located outside of the field of view of the user's eye 690. For example, one or more reflectors or directional couplers as shown in, for example, FIG. 4, may be used to reflect light from an image source to make the image source appear to be at the location of image source 620 shown in FIG. 6. Image source 620 may be similar to image source 412 described above. Light from an area (e.g., a pixel or a light emitting source) on image source 620 may be directed to user's eye 690 by projector optics 610. Light directed by projector optics 610 may form virtual images on an image plane 630. The location of image plane 630 may be determined based on the location of image source 620 and the focal length of projector optics 610. A user's eye 690 may form a real image on the retina of user's eye 690 using light directed by projector optics 610. In this way, objects at different spatial locations on image source 620 may appear to be objects on an image plane far away from the eye at different viewing angles.

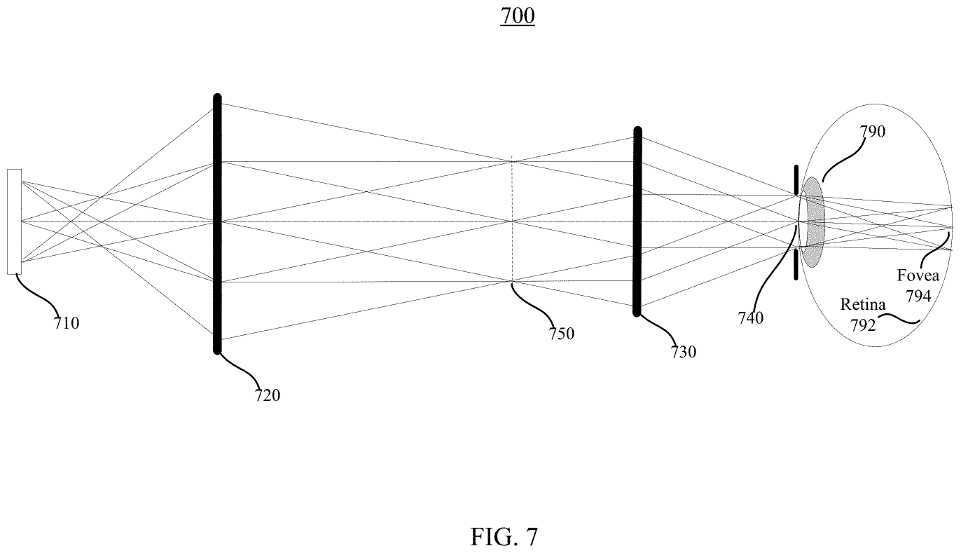

FIG. 7 illustrates an example optical system 700 with a pupil forming configuration for a near-eye display device according to certain embodiments. Optical system 700 may include an image source 710, a first relay lens 720, and a second relay lens 730. Even though image source 710, first relay lens 720, and second relay lens 730 are shown as in front of the user's eye 790, one or more of them may be physically located outside of the field of view of the user's eye 790 when, for example, one or more reflectors or directional couplers are used to change the propagation direction of the light. Image source 710 may be similar to image source 412 described above. First relay lens 720 may include one or more lenses, and may produce an intermediate image 750 of image source 710. Second relay lens 730 may include one or more lenses, and may relay intermediate image 750 to an exit pupil 740. As shown in FIG. 7, objects at different spatial locations on image source 710 may appear to be objects far away from the user's eye 790 at different viewing angles. The light from different angles may then be focused by the eye onto different locations on retina 792 of the user's eye 790. For example, at least some portion of the light may be focused on fovea 794 on retina 792.

### III. Adaptive Lens for Near-Eye Display

A. Vergence-Accommodation Conflict

In a natural environment, a viewer adjusts the eyes' focal power (i.e., accommodate) to guarantee sharp retinal images, and adjusts the angle between the eye's lines of sight (vergence) such that both eyes are directed to the same point. For example, to form a sharp image of an object on the retina, the eyed need to accommodate to a distance close to the focal distance of the object. The acceptable range is the depth of focus, which is about ±0.3 diopters (D) under normal circumstances. For an object to be seen as a single (i.e., fused) object rather than double objects, the eyes' lines of sight need to converge at a distance close to the object distance. The tolerance range is the Panum's fusion area, which is about 15 to 30 arcmin. Thus, vergence errors larger than about 15 to 30 arcmin may cause a breakdown in binocular fusion. To clearly view the object as a single object, the accommodation distance and the vergence distance need to be closely coupled.

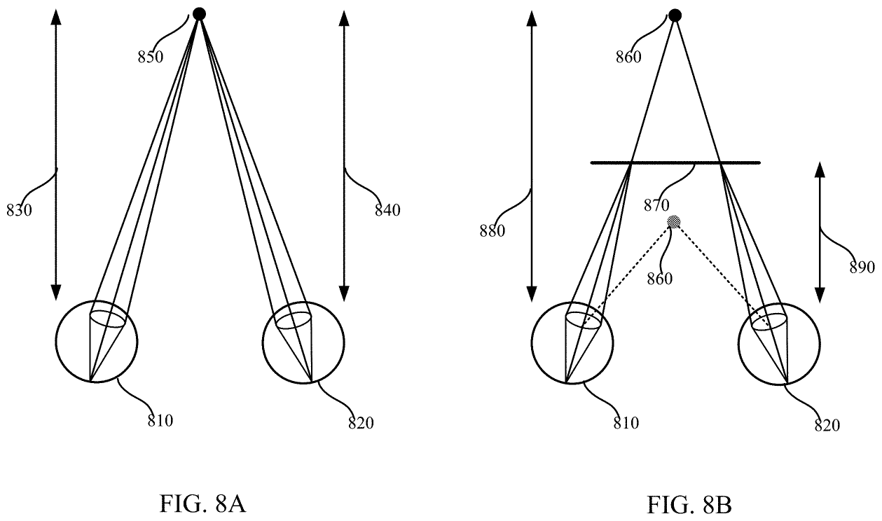

FIG. 8A illustrates the coupling between the focal distance and vergence distance in a natural environment. In the natural environment, the vergence and accommodation responses are neurally coupled or correlated. More specifically, the distance to which the eyes converge and the distance to which the eyes accommodate are always the same no matter where the viewer looks. Accommodative changes would evoke vergence changes (referred to as accommodative vergence), and vergence changes would evoke accommodative changes (referred to as vergence accommodation). One benefit of the coupling is an increased speed of accommodation and vergence. As shown in FIG. 8A, when looking at a target point 850 in the natural environment, the gaze directions of the left eye 810 and right eye 820 of the viewer, and thus the angle between the eye's lines of sight (vergence), can be naturally adjusted such that both eyes are directed to the same point. At the same time, the eyes' focal powers are also naturally adjusted to guarantee sharp retinal images (i.e., accommodation). Thus, the vergence distance 830 and focal distance 840 are the same.

In artificial reality displays (e.g., stereoscopic VR or AR displays), the coupling between focal and vergence distances may sometime be disrupted because the focal distance is fixed at the image plane while the vergence distance varies depending on the part of the simulated scene the viewer fixates. Thus, a discrepancy between the two responses occurs because the eyes must converge on the image content (which may be in front of or behind the image plane), and must accommodate to the distance of the image plane. The disruption of the natural correlation between the vergence and accommodation distances is often referred to as the vergence-accommodation conflict.

FIG. 8B illustrates the conflict between the focal distance and vergence distance in a near-eye display environment. When looking at an intended point 860 at a vergence distance 880, the gaze directions of the left eye 810 and right eye 820 of the viewer, and thus the angle between the eye's lines of sight, need to be adjusted such that both eyes are directed to the intended point. On the other hand, because the actual image is displayed at image plane 870, the eyes' focal powers need to be adjusted to focus on the image plane. Thus, the focal distance 890 of the eye is the distance of image plane 870, which is often different from vergence distance 880. For example, in many existing near-eye displays, the image plane is at about 2 meters or about 3 meters in front of the user's eyes. However, the intended distance of a displayed object may be shorter or greater than 2 meters or 3 meters. Thus, the vergence distance may be shorter or greater than the focal distance.

The vergence-accommodation conflict has several adverse effects. For example, perceptual distortions may occur due to the conflicting disparity and focus information. It may be difficult to simultaneously fuse and focus a stimulus (e.g., an intended object) because the viewer needs to adjust vergence and accommodation to different distances. If the accommodation is accurate, the viewer may see the object clearly, but may see double images. If the vergence is accurate, the viewer may see one fused object, but it may be blurred. Visual discomfort may occur as the user attempts to adjust both the vergence and the accommodation. The set of vergence and accommodative responses that may not cause eye discomfort is the Percival's zone of comfort, which is about one-third of the width of the zone of clear single binocular vision. Stimuli (e.g., target objects) in the real world fall within the comfort zone, while many stimuli in 3D displays do not. To fuse and focus the stimuli in 3D displays, the viewer may need to counteract the normal accommodation-vergence coupling, and the effort involved is believed to cause viewer fatigue and discomfort during a prolonged use of near-eye displays.

B. Adaptive Lens for Near-Eye Display

To reduce the ocular stress, a near-eye display device may need to be able to display images at multiple image planes. The distance of the image plane may need to be changed based on the vergence distance of the content displayed. For content having a longer vergence distance, the image plane may need to be at a longer distance from the user's eye. For example, the image plane may be set at 0.6 meters in front of the user's eyes when the vergence distance is less than about 1 meter, and the image plane may be set at 2 meters in front of the user's eyes when the vergence distance is greater than about 1 meter. In this way, the vergence distance and the focal distance are coupled or correlated to reduce the vergence-accommodation conflict and thus the eye stress. To have even better correspondence between convergence distance and accommodation, three and more image planes can be created.

According to certain embodiments, a lens stack (e.g., a liquid crystal lens stack) is used to form a switchable lens assembly that can adaptively project images at two or more image planes. The lens stack may include at least two liquid crystal (LC) lenses or other lenses sensitive to either linearly or circularly polarized light. The stack also includes one or more switchable polarization converters rotating linear polarization in 90° or changing handedness of circular polarization. These converters may be placed in front of the lens stack or between the lenses and can be switched simultaneously or in different time to achieve multiple image planes.

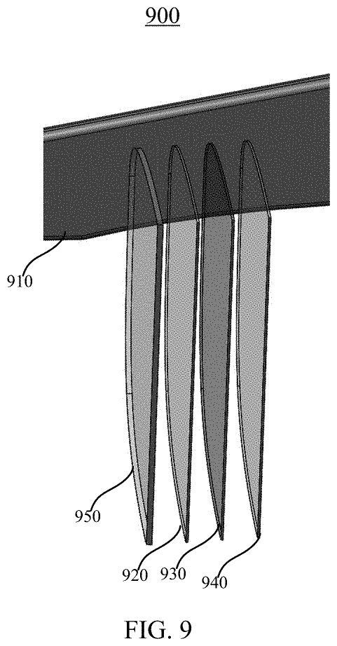

FIG. 9 illustrates an example liquid crystal lens stack 900 for displaying images on two discrete image planes according to certain embodiments. In some embodiments, liquid crystal lens stack 900 includes a first liquid crystal lens 920, a polarization converter 930, and a second liquid crystal lens 940. First liquid crystal lens 920 and second liquid crystal lens 940 may be passive or active liquid crystal lenses that are polarization-dependent. In some embodiments, first liquid crystal lens 920 and second liquid crystal lens 940 may be linear polarization sensitive, and polarization converter 930 may be a polarization rotator. For example, first liquid crystal lens 920 may have a first (positive or negative) optical power (e.g., x) for light in a first linear polarization state (e.g., linearly polarized at an alignment direction θ). The first optical power may correspond to a first focal distance of the liquid crystal lens stack and thus a first virtual image distance for the displayed images. Second liquid crystal lens 940 may have a second (positive or negative) optical power (e.g., y) for light in a second linear polarization state (e.g., linearly polarized at an alignment direction θ+90′). The second optical power may correspond to a second focal distance of the liquid crystal lens stack and thus a second virtual image distance for the displayed images. First liquid crystal lens 920 may have a zero optical power for light in the second linear polarization state and second liquid crystal lens 940 may have a zero optical power for light in the first linear polarization state. Polarization converter 930 may be configured to rotate display light from the first polarization state to the second polarization state or vice versa. Polarization converter 930 may be positioned between first liquid crystal lens 920 and second liquid crystal lens 940, or may be positioned such that first liquid crystal lens 920 and second liquid crystal lens 940 are on a same side of polarization converter 930. In some embodiments where the display light (e.g., from a waveguide display) is not linearly polarized, liquid crystal lens stack 900 may also include a polarizer 950 for polarizing the display light. Liquid crystal lens stack 900 may be attached to a frame 910 of a near-eye display device.

In another embodiment, first liquid crystal lens 920 may have a first (positive or negative) optical power (e.g., x) and second liquid crystal lens 940 may have a second (positive or negative) optical power (e.g., y) for light in a first linear polarization state. Both LC lenses 920 and 940 may have a zero optical power for light in a second linear polarization state. Polarization converter 930 configured to rotate display light from the first linear polarization state to the second linear polarization state or vice versa may be placed between the first liquid crystal lens 920 and the second liquid crystal lens 940. When polarization converter 930 is in the OFF state (i.e., no polarization rotation), the optical power of lens stack 900 is x+y, which corresponds to a focal distance 1/(x+y). When polarization converter 930 is in the ON state, the optical power of lens stack 900 is x, which corresponds to a focal distances 1/x.

In yet another embodiment, first LC lens 920 and second LC lens 940 may have positive optical power x and y, respectively, for light in a first circular polarization state (e.g., right-handed circular polarization (RCP)). Polarization converter 930 may be a polarization converter that can convert right-handed circular polarization to left-handed circular polarization, or vice versa. For example, in some embodiments, polarization converter 930 may include a half-wave plate and may be placed between the first LC lens 920 and the second LC lens 940. When polarization converter 930 is in the OFF state (i.e., no polarization conversion), the RCP light may become left-handed circularly polarized (LCP) light after passing through first LC lens 920, and the LCP light may then pass through polarization converter without changing this polarization state. The second LC lens 940 may have a negative optical power −y for the LCP light. As a result, the optical power of lens stack 900 is x−y. When polarization converter 930 is in the ON state, the RCP light may become LCP light after passing through first LC lens 920, and the LCP light may then be converted back to RCP light after passing through polarization converter 930. Second LC lens 940 may have a positive power y for the RCP light. As a result, the optical power of lens stack 900 is x+y.

FIG. 9 shows one example configuration or stack-up of the liquid crystal lens stack. First liquid crystal lens 920, polarization converter 930, second liquid crystal lens 940, and/or polarizer 950 in the liquid crystal lens stack can also be arranged in other ways. In one implementation, the stack-up may be in the order of polarizer 950 (optional), polarization converter 930, first liquid crystal lens 920, and second liquid crystal lens 940, after a display. In another implementation, the stack-up may be in the order of polarizer 950 (optional), polarization converter 930, second liquid crystal lens 940, and first liquid crystal lens 920. In yet another implementation, the stack-up may be in the order of polarizer 950 (optional), second liquid crystal lens 940, polarization converter 930, and first liquid crystal lens 920.

In some embodiments where polarization converter 930 is between first liquid crystal lens 920 and second liquid crystal lens 940, light from the display (e.g., an LCD or a waveguide display) may first be polarized to, for example, linearly or circularly polarized light by polarizer 950 if the display light from the display is not polarized. For example, polarizer 950 may polarize the display light such that the display light passing through polarizer 950 may be linearly polarized at an alignment direction θ. First liquid crystal lens 920 may have a non-zero optical power for light in the first linear polarization state, first liquid crystal lens 920 may project the display image on an image plane at a first virtual image distance associated with the non-zero optical power of first liquid crystal lens 920. Polarization converter 930 may be in an “OFF” state (no rotation) and thus would not change the polarization state of the light passing through polarization converter 930. Second liquid crystal lens 940 may have a zero optical power for light in the first linear polarization state and thus would not change the distance of the image plane. Thus, the image formed by liquid crystal lens stack 900 when polarization converter 930 is in the “OFF” state is at the first virtual image distance. When polarization converter 930 is switched to an “ON” state (with rotation) and thus would change the polarization state of the light passing through polarization converter 930, for example, from the first linear polarization state to a second linear polarization state. Second liquid crystal lens 940 may have a non-zero optical power for light in the second linear polarization state, and thus would change the distance of the image plane. Thus, the image formed by liquid crystal lens stack 900 when polarization converter 930 is in the “ON” state is at a second virtual image distance associated with the combined optical power of first liquid crystal lens 920 and second liquid crystal lens 940.

In some embodiments where first liquid crystal lens 920 and second liquid crystal lens 940 are linear polarization sensitive and are on a same side of polarization converter 930 (which is between polarizer 950 and the two LC lenses), light from the display or after passing through polarizer 950 may be in the first polarization state, such as linearly polarized at an alignment direction θ. Polarization converter 930 may be in an “OFF” state (no rotation) and thus would not change the polarization state of the light passing through polarization converter 930. As such, the display light in the first polarization state may reach first liquid crystal lens 920. Because first liquid crystal lens 920 may have a non-zero optical power for light in the first polarization state, first liquid crystal lens 920 may project the display image on an image plane at a first virtual image distance associated with the non-zero optical power of first liquid crystal lens 920. Second liquid crystal lens 940 may have a zero optical power for light in the first polarization state and thus would not change the distance of the image plane. Thus, the image formed by liquid crystal lens stack 900 when polarization converter 930 is in the “OFF” state is at the first virtual image distance. When polarization converter 930 is switched to an “ON” state (with rotation), it may change the polarization state of the light passing through polarization converter 930, for example, from the first polarization state to the second polarization state. Because first liquid crystal lens 920 may have a zero optical power for light in the second polarization state, first liquid crystal lens 920 may not change the wavefront of the display light. However, because second liquid crystal lens 940 may have a non-zero optical power for light in the second polarization state, second liquid crystal lens 940 would project the display image on an image plane at a second virtual image distance associated with the non-zero optical power of the second liquid crystal lens. Thus, the image formed by liquid crystal lens stack 900 when polarization converter 930 is in the “ON” state is at the second virtual image distance.

In this way, liquid crystal lens stack 900 may form a switchable lens assembly that can adaptively project images at two or more image planes. In various embodiments, the liquid crystals for the LC lenses may include active LCs switchable in electric field or passive LCs (e.g., reactive mesogen), the layer of which may be cross-linked after the formation of alignment structure. In one embodiment, the LCs include nematic LCs. In some embodiments, other polarization-dependent lenses, rather than liquid crystal lenses, may be used in a lens stack to form the switchable lens assembly. In some embodiments, the liquid crystal lens may be a passive lens or an active lens that can be electrically adjusted. In some embodiments, one liquid crystal lens in a lens stack may be a passive lens, while another liquid crystal lens in the stack may be an active lens. In some embodiments, one or more liquid crystal lens stacks may be used in a near-eye display device for virtual reality or augmented reality applications. For example, two or more liquid crystal lens stacks may be used in a near-eye display device to achieve more than two different image planes.

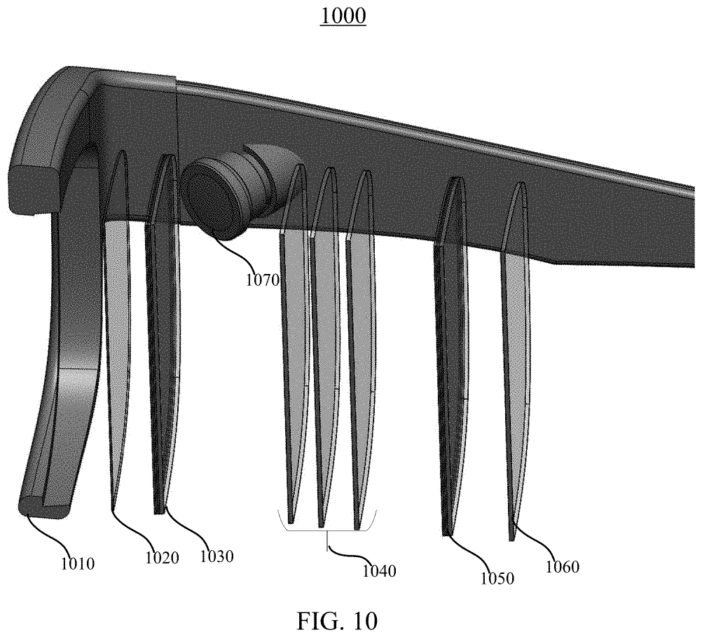

FIG. 10 is an exploded view of an example near-eye display device 1000 according to certain embodiments. Near-eye display device 1000 may include a frame 1010, a waveguide display 1040, and a first lens stack 1050. First lens stack 1050 may include a lens stack that include two or more polarization-dependent lenses and a switchable polarization converter as described above with respect to liquid crystal lens stack 1000. In some implementations, waveguide display 1040 may include multiple (e.g., 3) waveguide displays, where each waveguide display may display images in one wavelength (e.g., red, green, or blue). The images may be generated by an image source and coupled into waveguide display 1040 as described above with respect to, for example, FIG. 4. In VR applications, images displayed by waveguide display 1040 may be projected by first lens stack 1050 on an image plane at a first virtual image distance or a second virtual image distance, for example, by switching the switchable polarization converter on or off as described above with respect to FIG. 10.

In some embodiments, near-eye display device 1000 may include a second lens stack 1030. Second lens stack 1030 may also include two or more polarization-dependent lenses and a switchable polarization converter as described above with respect to liquid crystal lens stack 1000. The two or more polarization-dependent lenses in second lens stack 1030 may have optical powers opposite to the optical powers of the two or more polarization-dependent lenses in first lens stack 1050. For example, if two linear polarization-dependent lenses in first lens stack 1050 have optical powers about x and about y, respectively (where x and y may be positive or negative), two polarization-dependent lenses in second lens stack 1030 may have optical powers about −x and about −y, respectively. As such, the total optical power of first lens stack 1050 and second lens stack 1030 may be close to zero or less than about ±0.25 diopter. As described above with respect to FIG. 4, in some implementations, waveguide display 1040 may be substantially transparent for ambient visible light. Therefore, in augmented reality applications, first lens stack 1050, waveguide display 1040, and second lens stack 1030 may have little or no effect on light from the ambient environment in front of near-eye display device 1000, such that the user can view the real world environment with little or no distortion. At the same time, waveguide display 1040 and first lens stack 1050 may be used to display computer-generated artificial images to the user.

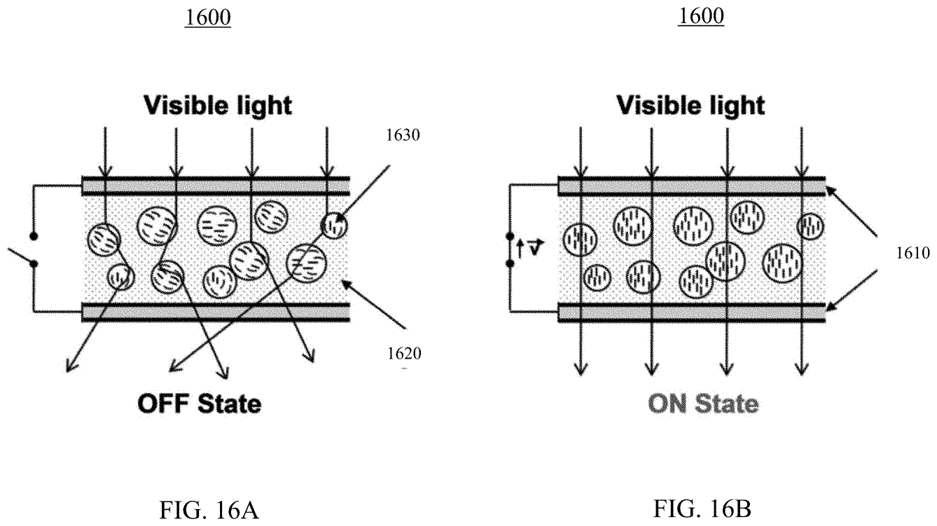

In some embodiments, near-eye display device 1000 may include an eye-tracking system, which may include an eye-tracking element 1060 and a camera 1070 for tracking the movement of the user's eyes as described above with respect to FIG. 1. For example, eye-tracking element 1060 may direct infrared light to the user's eyes and direct infrared light reflected by the user's eyes to camera 1070. The image captured by camera 1070 may be analyzed to determine the movement of the user's eyes. In some embodiments, near-eye display device 1000 may include an adaptive dimming element 1020. Adaptive dimming element 1020 may include an LC material layer that can be tuned by applying an electrical field to change an orientation of the LC molecules, thus changing the transmission rate of the adaptive dimming element. More detail of the adaptive dimming element is described below with respect to, for example, FIGS. 16A-18B. In some embodiments, near-eye display device 1000 may further include a photovoltaic material layer that can absorb invisible light (e.g., infrared and/or ultra-violet light) and convert the invisible light to electrical power to provide power to, for example, the switchable polarization converter and/or the adaptive dimming element.

C. Liquid Crystal Lens

As described above, the adaptive lens assembly may include polarization-dependent lenses. There may be many different ways to implement the polarization-dependent lens, which may be active or passive lens and may be sensitive to linearly polarized light or circularly polarized light. As described above, in some implementations, the polarization-dependent lens may include a liquid crystal lens. The liquid crystal lens may include, for example, a plane-convex LC lens combined with a plane-concave polymer or glass lens, where the alignment of the liquid crystal molecules at the flat and curved boundaries is provided by photo-alignment, rubbing, or other suitable alignment methods. In some implementations, the liquid crystal lens may include a flat lens, where the no-zero optical power of the lens is provided by the refractive index gradient caused by the variation of the pre-tilt angle of the liquid crystal molecules at different areas of the lens. The variation of the pre-tilt angle of the liquid crystal molecules can be achieved by, for example, photo-alignment, micro-rubbing, non-uniform surface polymerization combined with rubbing, creation of surface polymer network, gradient of easy axis or anchoring energy, etc. In some implementations, the liquid crystal lens may include a diffractive optical element (e.g., a Fresnel lens), and the zones of the diffractive optical element (e.g., the Fresnel zones) may be formed by patterned LC alignment or by phase separation patterning of LC layer doped with pre-polymers. The alignment pattern may be created by, for example, photo-alignment. In some implementations, the liquid crystal lens may include a Pancharatnam-Berry phase (PBP) lens (i.e., geometric-phase lens) that is flat and is sensitive to circularly polarized light. The PBP lens or geometric-phase lens is based on the gradient of geometric phase within the lens, which can be induced by, for example, polarization holography or direct optical writing.

Liquid crystal lens may include, for example, nematic liquid crystal lens, polymer-stabilized nematic liquid crystal lens, polymer-stabilized blue phase liquid crystal lens, polymer-dispersed nematic liquid crystal lens, etc. Nematic liquid crystals include rod-like molecules, which exhibit optical and dielectric anisotropies due to their anisotropic molecular structures. When properly aligned in an LC cell, the long axes of the nematic liquid crystal molecules are approximately parallel to each other, where the alignment direction is referred to as the LC director. Light polarized along the LC director (the extraordinary ray) sees extraordinary refractive index nₑ, while light polarized perpendicular to the LC director (the ordinary ray) sees ordinary refractive index nₒ. If the light is polarized at an angle θ with respect to the LC director, it may see an effective refractive index n_{eff}(θ):

$${n}_{eff} ( θ ) = \frac{{n}_{e} {n}_{o}}{\sqrt{{( {n}_{e} sin θ )}^{2} + {( {n}_{o} cos θ )}^{2}}} . \qquad ( 1 )$$

The dielectric anisotropy can be described as:

Δε=ε/−ε⊥, (2)

where ε// and ε⊥ are the dielectric constant (or relative permittivity) along and perpendicular to the LC director, respectively. The birefringence (optical anisotropy) of the LC can be expressed as:

Δn=nₑ−nₒ. (3)

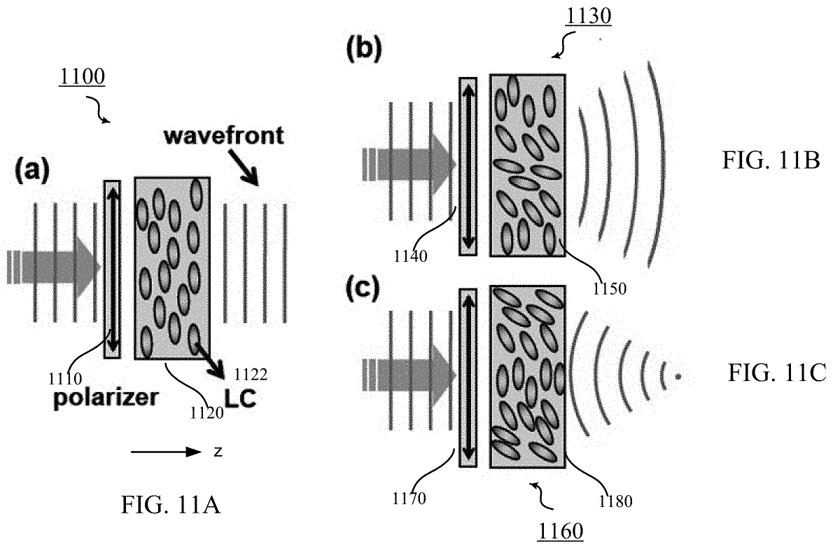

FIG. 11A illustrates an example liquid crystal device 1100 with a zero optical power. Liquid crystal device 1100 may include a liquid crystal cell 1120 and a polarizer 1110. In liquid crystal cell 1120, LC 1122 is sandwiched between two substrates coated with surface alignment layers (e.g., polyimide (PI)) and, optionally, electrodes (e.g., indium tin oxide (ITO)). The two substrates may be separated by a spacer that controls the cell gap (or thickness). The surface alignment layers cause the alignment of LC directors. Liquid crystal cell 1120 may be a homogeneous LC cell, where the top and bottom substrates may be rubbed in anti-parallel directions and the LC directors are aligned along the substrates in the static state. Polarizer 1110 may be a linear polarizer in the example shown in FIG. 11A. When light linearly polarized along the rubbing direction by polarizer 1110 is normally incident on liquid crystal cell 1120, it may experience an optical path L=dnₑ in the vertical direction, where d is the thickness of liquid crystal cell 1120. Because LC 1122 is aligned homogeneously in liquid crystal cell 1120, the wavefront of the incident light is not modified by liquid crystal cell 1120 as shown in FIG. 11A. As a result, the focal length of liquid crystal device 1100 is at infinity (i.e., a zero optical power).

FIG. 11B illustrates an example liquid crystal device 1130 with a negative optical power. As liquid crystal device 1100, liquid crystal device 1130 may include a liquid crystal cell 1150 and a polarizer 1140. Polarizer 1140 may be a linear polarizer in the example shown in FIG. 11B. Liquid crystal cell 1150 may include liquid crystal molecules aligned in different directions at different areas of liquid crystal cell 1150. When light linearly polarized along the rubbing direction by polarizer 1110 is normally incident on liquid crystal cell 1150, it may experience different optical path at different areas of liquid crystal cell 1150. In areas where the LC molecules are aligned along the polarization direction of the incident light, the incident light may experience an optical path length L=dnₑ. In areas where the alignment direction of the LC molecules is perpendicular to the polarization direction of the incident light, the incident light may experience an optical path length L=dnₒ. In areas where the directors of LC molecules and the polarization direction of the incident light form an angle θ, the incident light may experience an optical path length:

L=∫₀^{d}n_{eff}(θ)dz, (4)

where the effective refractive index n_{eff}(θ) can be determined using Equation (1).

In liquid crystal cell 1150, the alignment direction of the LC molecules is pre-tilted such that the pre-tilt angle θ smoothly changes from about 90° (i.e., perpendicular or homeotropic alignment) around the center to 0° (i.e., planar alignment) on the edge of the liquid crystal cell. Thus, the optical path difference (OPD) between the edge area and other areas of LC cell 1150 can be expressed as:

OPD=d(nₑ−n_{eff}(θ)). (5)

Therefore, LC cell 1150 exhibits a refractive index gradient and hence a lens-like phase profile. Thus, LC cell 1150 is equivalent to a lens having an isotropic medium with different thicknesses at different areas of the lens. The focal length of LC cell 1150 may be given by:

$$f = \frac{ π {D}^{2}}{4 λ Δ δ} , \qquad ( 6 )$$

where D is the aperture size (e.g., the diameter) of LC cell 1150, λ is the wavelength, Δδ is the phase difference between the edge and center areas of the aperture and can be expressed as:

$$Δδ = \frac{2 π}{λ} d Δ n , \qquad ( 7 )$$

where Δn is the difference in refractive index between the center and edge areas of the aperture. Thus, the focal length of LC cell 1150 can be rewritten as:

$$f = \frac{{r}^{2}}{2 d Δ n} , \qquad ( 8 )$$

where r is the radius of the aperture of LC cell 1150. When the refractive index in the center area is less than that of the edge area as in FIG. 11B, Δn is negative and thus f is negative. Therefore, liquid crystal device 1130 may be a negative lens for the linearly polarized light from polarizer 1140.

The refractive index gradient and the gradient of the pre-tilt angle of the LC directors can be introduced by, for example, an inhomogeneous electric field, inhomogeneous LC morphology, photo-alignment, micro-rubbing, non-uniform surface polymerization combined with rubbing, creation of surface polymer network, gradient of easy axis or anchoring energy, etc.

FIG. 11C illustrates an example liquid crystal device 1160 with a positive optical power. Liquid crystal device 1160 may include a liquid crystal cell 1180 and a polarizer 1170. Polarizer 1170 may be a linear polarizer in the example shown in FIG. 11C. Liquid crystal cell 1180 may include liquid crystal molecules aligned in different directions at different areas of liquid crystal cell 1180. In the center of liquid crystal cell 1180, the alignment direction of the LC molecules is planar and parallel to the polarization direction of the incident light (and thus the refractive index is around nₑ), and the LC alignment direction at other areas is pre-tilted with increasing pre-tilt angle θ from center to edge. At the edge, the alignment is substantially homeotropic or perpendicular to the polarization direction of the incident light (and thus a refractive index is around nₒ). Because the refractive index in the center area (nₑ) of liquid crystal cell 1180 is greater than that of the edge area (nₒ), Δn is positive, and thus f determined based on Equation (8) is positive. Therefore, liquid crystal device 1160 may be a positive lens for the linearly polarized light from polarizer 1170.

D. Switchable Polarization Rotator

Polarization converters (e.g., switchable polarization converter 930), such as linear polarization rotators or circular polarization converters, may be implemented using wave plates. For example, a half-wave plate with the axis of the wave plate at an angle θ with respect to the polarization direction of the incident light can rotate the polarization direction of the incident light by 2θ. In particular, a half-wave plate with its axes oriented at 45° with respect to the polarization direction of the incident light may be used to rotate the polarization direction by 90°.

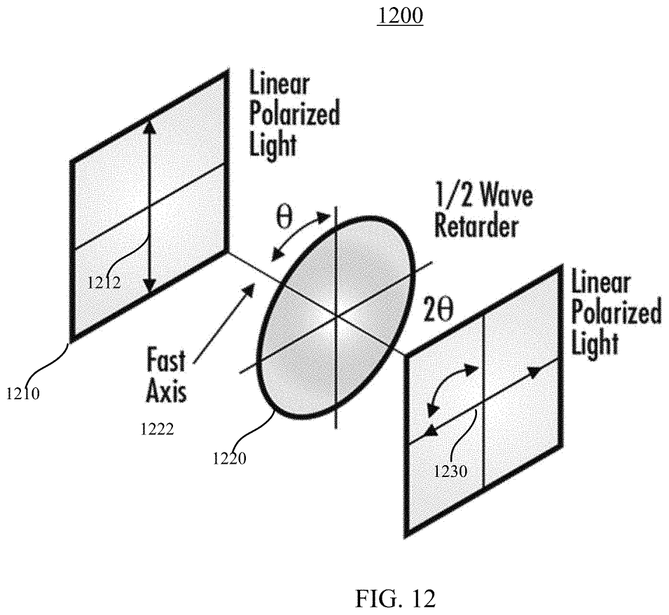

FIG. 12 illustrates an example linear polarization rotator based on a half-wave plate. The linear polarization rotator is configured to rotate the polarization direction of linearly polarized light. A linear polarizer 1210 may linearly polarize incident light along a polarization direction 1212. A half-wave plate 1220 with a fast axis 1222 at an angle θ with respect to polarization direction 1212 can rotate to polarization direction of the linearly polarized light by an angle 2θ. When angle θ is 45°, the vertically polarized light can be converted to horizontally polarized light 1230. A half-wave plate can also change the handedness of circularly polarized light.

In optical systems, the polarization rotators (e.g., half-wave plates) are often implemented using quartz retardation plates. Quartz plates may have high quality and good transmission performances, but they are generally expensive and are not switchable, and they may function only for a narrow spectral bandwidth (i.e., chromatic) and have a small field of view (e.g., less than 2°). In some embodiments, the half-wave plate may be an active liquid crystal cell with a half-wave retardation, where the half-wave plate may be switchable, but may also function only for a narrow spectral bandwidth (i.e., chromatic). For example, LC cells with uniform planar alignment of LC may provide a phase shift Δδ=π between the light with polarization parallel and perpendicular to the optical axis of the LC cells. These LC cells may include transparent electrodes (e.g., ITO electrodes) to apply electric field across the cell and realize planar to homeotropic reorientation of LC layer.

According to certain embodiments, twisted nematic liquid crystal cell (TN cell) can be used to rotate the orientation of a linearly polarization light by a fix amount of, for example, 45° or 90°. When light is traversing a twisted nematic LC cell, its polarization direction may follow the rotation of the molecules. The nematic liquid crystal cells have a large acceptance angle, function over a very large spectral range from VIS to NIR, and are less expensive. In addition, by applying a voltage signal on the TN cell, the polarization rotation can be switched on or off In contrast to polarization rotators based on half-wave plates, TN cell-based polarization rotators can be achromatic.

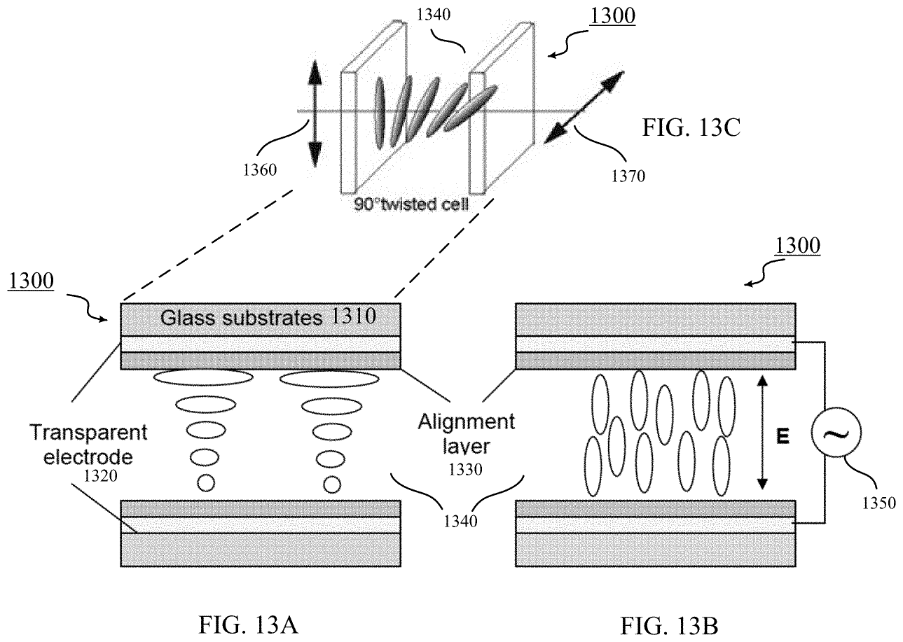

FIGS. 13A-13C illustrate an example achromatic liquid crystal polarization rotator 1300 based on TN cell according to certain embodiments. In the example, the achromatic liquid crystal polarization rotator is a 90° TN liquid crystal cell in which light propagates in the Mauguin regime. FIG. 13A illustrates achromatic liquid crystal polarization rotator 1300 in an “ON” state (i.e., the LC cell is in the field-off state) where the switchable liquid crystal polarization rotator is configured to change the polarization state of incident light. FIG. 13B illustrates the achromatic liquid crystal polarization rotator in an “OFF” state (i.e., the LC cell is in the field-on state) where the switchable liquid crystal polarization rotator would not change the polarization state of incident light. FIG. 13C illustrates the rotation of linearly polarized light by the achromatic liquid crystal polarization rotator in the “ON” state. Achromatic liquid crystal polarization rotator 1300 may include two substrates 1310 (e.g., glass substrates) forming a cavity, transparent electrode layers 1320 (e.g., ITO), alignment layers 1330 (e.g., rubbed polyimide layers), and a liquid crystal layer 1340 including liquid crystal molecules. By controlling the rubbing directions of the alignment layers, a twist-angle can be induced across the liquid crystal layer. With a twist-angle of 90° as shown in FIG. 13A, the twisted nematic cell can be used to rotate the polarization of linearly polarized light by 90°.

When achromatic LC polarization rotator 1300 is in the “ON” state as shown in FIG. 13A, the helical structure formed by the LC molecules may rotate incident linearly polarized light 1360 (e.g., vertically polarized) by 90° into linearly polarized light 1370 (e.g., horizontally polarized) as shown in FIG. 13C. When a voltage signal 1350 is applied to transparent electrode layers 1320, the liquid crystal molecules may be realigned such that the directors of the liquid crystal molecules are all parallel to the electric field E in liquid crystal layer 1340. As such, the polarization rotation power of achromatic LC polarization rotator 1300 is suspended (i.e., in the “OFF” state) and the polarization state of the incident light is not altered by achromatic LC polarization rotator 1300. The efficiency of the polarization rotation may depend on the thickness of liquid crystal layer 1340 and the anisotropy of the refractive index of the liquid crystal material.

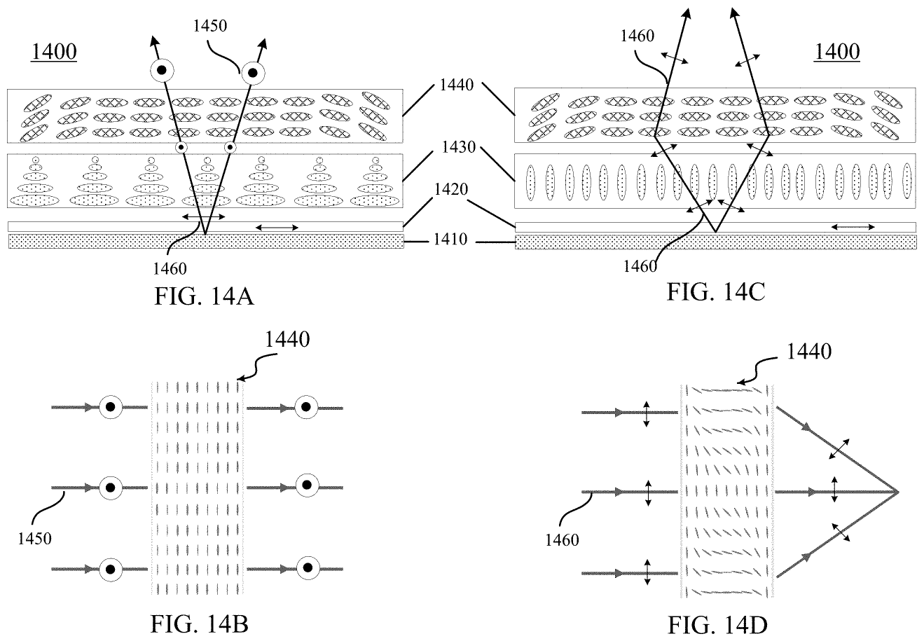

FIGS. 14A-14D illustrate an example near-eye display device 1400 having a switchable optical power. Near-eye display device 1400 may include a display 1410 (e.g., an optical or electrical display), an optional polarizer 1420, a switchable polarization rotator 1430, and a liquid crystal lens 1440. Polarizer 1420 may linearly polarize display light from display 1410 if the display light is not linearly polarized. Switchable polarization rotator 1430 may include, for example, achromatic TN cell-based LC polarization rotator 1300 described above. Liquid crystal lens 1440 may include, for example, liquid crystal device 1130 or 1160 described above. In the example shown in FIGS. 14A-14D, liquid crystal lens 1440 may have a zero optical power for s-polarized light and may have a first non-zero optical power for p-polarized light.

FIG. 14A illustrates near-eye display device 1400 having a zero optical power when switchable polarization rotator 1430 is in an “ON” state, where the near-eye display device includes a twisted nematic liquid crystal cell-based polarization rotator and a linear polarization-dependent LC lens. FIG. 14B illustrates polarization-dependent liquid crystal lens 1440 having a zero optical power for light in a first linear polarization state (e.g., s-polarized display light 1450). In the example shown in FIGS. 14A-14D, display light from display 1410 may be p-polarized by polarizer 1420. When switchable polarization rotator 1430 is in the “ON” state, switchable polarization rotator 1430 may rotate the p-polarized display light 1460 into s-polarized display light 1450. Because liquid crystal lens 1440 is polarization sensitive and has a zero optical power for s-polarized display light 1450, near-eye display device 1400 may have a zero optical power.

FIG. 14C illustrates near-eye display device 1400 having a non-zero optical power when the switchable polarization rotator is in an “OFF” state. FIG. 14D illustrates polarization-dependent liquid crystal lens 1440 having a non-zero optical power for light in a second linear polarization state (e.g., p-polarized display light 1460). Display light from display 1410 may be p-polarized by polarizer 1420. When switchable polarization rotator 1430 is set to the “OFF” state by applying an electric field in switchable polarization rotator 1430, switchable polarization rotator 1430 may not rotate the p-polarized display light 1460 as described above. Because liquid crystal lens 1440 is polarization sensitive and has a first non-zero optical power for p-polarized display light 1460, near-eye display device 1400 may have the first non-zero optical power. Thus, the optical power of near-eye display device 1400 can be switched from zero to a non-zero value, or vice versa.

A second liquid crystal lens having different polarization sensitivity than liquid crystal lens 1440 may be added to near-eye display device 1400 to make a device having two switchable non-zero optical powers. For example, the second liquid crystal lens may have a second non-zero optical power for s-polarized light and a zero optical power for p-polarized light. Thus, when the switchable polarization rotator is in the “ON” state, the near-eye display device may have the second non-zero optical power due to the second liquid crystal lens. when the switchable polarization rotator is in the “OFF” state, the near-eye display device may have the first non-zero optical power due to liquid crystal lens 1440.

E. Adaptive Lens Sensitive to Circularly Polarized Light

As described above, in some implementations, the liquid crystal lens may include at least one Pancharatnam-Berry phase (PBP) lens or other geometric-phase lens that is flat and is sensitive to circularly polarized light. The PBP lens or geometric-phase lens is based on the gradient of geometric phase within the lens, which can be induced by, for example, polarization holography or direct optical writing. PBP lenses can generally include half-wave plates whose crystal-axis is changing spatially in a specific way, and thus can accumulate a spatial-varying phase.

More specifically, the Jones vectors of left- and right-handed circularly polarized light (LCP and RCP) can be described as:

$${J}_{\pm } = \frac{1}{\sqrt{2}} [ \begin{matrix}1 \\ \pm j\end{matrix} ] , \qquad ( 9 )$$

where J+ and J− represent the Jones vectors of left- and right-handed circularly polarized light, respectively. For PBP lenses, the local azimuthal angle ψ(r) may vary according to:

$$\pm 2 ψ ( r ) = ϕ ( r ) = - \frac{ω}{c} ( \sqrt{{r}^{2} + {f}^{2}} - f ) \qquad ( 10 )$$

in order to achieve a centrosymmetric parabolic phase distribution, where φ, ω, c, r, and f are the relative phase, angular frequency, speed of light in vacuum, radial coordinate, and focal length of the lens, respectively. After passing through the PBP lens, the Jones vectors may be changed to:

$$\begin{matrix}{J}_{\pm }^{′} = R ( - ψ ) W ( π ) R ( ψ ) {J}_{\pm } \\ = [ \begin{matrix}cos ψ & - sin ψ \\ sin ψ & cos ψ\end{matrix} ] [ \begin{matrix}{e}^{- j \frac{π}{2}} & 0 \\ 0 & {e}^{- j \frac{π}{2}}\end{matrix} ] [ \begin{matrix}cos ψ & sin ψ \\ - sin ψ & cos ψ\end{matrix} ] \frac{1}{\sqrt{2}} [ \begin{matrix}1 \\ \pm j\end{matrix} ] \\ = \frac{- j {e}^{\pm 2 j ψ}}{\sqrt{2}} [ \begin{matrix}1 \\ ∓ j\end{matrix} ] = - j {e}^{\pm 2 j ψ} {J}_{∓} ,\end{matrix} \qquad ( 11 )$$

where R(ψ) and W(π) are the rotation and retardation Jones matrix, respectively. As can be seen from equation (11), the handedness of the output light is switched relative to the incident light. In addition, a spatial-varying phase depending on the local azimuthal angle ψ(r) is accumulated. Furthermore, the phase accumulation has opposite signs for RCP and LCP light, and thus the PBP lens may modify the wavefront of RCP and LCP incident light differently. For example, a PBP lens may have a positive optical power for RCP light, and a negative optical power for LCP light, or vice versa.

According to certain embodiments, one or more lenses sensitive to circularly polarized light may be used in an adaptive lens to achieve a switchable focal length. For example, one or more passive PBP lenses as described above may be used with a switchable polarization converter (e.g., a switchable half-wave plate) to achieve different focal lengths for incident light. Because the PBP lens(es) have different signs of optical power for circularly polarized light of different handedness, the overall optical power of the adaptive lens may be switched by switching on or off the switchable half-wave plate.

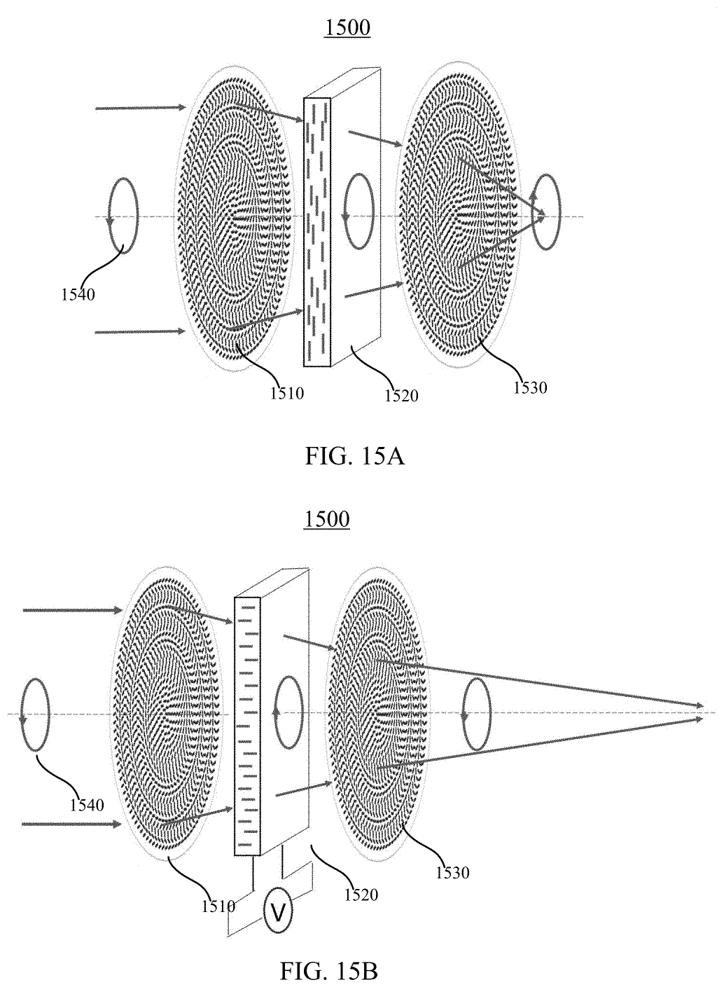

FIGS. 15A and 15B illustrate an example liquid crystal device 1500 including lenses sensitive to circularly polarized light according to certain embodiments. Liquid crystal device 1500 may include a first PBP lens 1510, a switchable half-wave plate 1520, and a second PBP lens 1530. First PBP lens 1510 and second PBP lens 1530 can be passive or active lenses, and can have a positive or negative optical power for RCP or LCP light in various embodiments. In one example, first PBP lens 1510 and second PBP lens 1530 may both have a positive optical power for RCP light and a negative optical power for LCP light. In another example, first PBP lens 1510 and second PBP lens 1530 may both have a negative optical power for RCP light and a positive optical power for LCP light. In yet another example, first PBP lens 1510 may have a positive optical power for RCP light, while second PBP lens 1530 may have a negative optical power for RCP light. Switchable half-wave plate 1520 may be a liquid crystal polarization converter that can be switched on or off by a voltage signal 1550 as described above. When no voltage signal is applied to switchable half-wave plate 1520, switchable half-wave plate 1520 may be in the “ON” state and may change the handedness of circularly polarized light passing through it. When a voltage signal is applied to switchable half-wave plate 1520, switchable half-wave plate 1520 may be in the “OFF” state and may not change the handedness of circularly polarized light passing through it.

In FIG. 15A, an RCP light beam 1540 is incident on liquid crystal device 1500, where no voltage signal is applied to switchable half-wave plate 1520 (i.e., switchable half-wave plate 1520 is in the “ON” state). First PBP lens 1510 may have an optical power D1 for RCP light, and second PBP lens 1530 may have an optical power D2 for RCP light. RCP light beam 1540 may enter first PBP lens 1510 and may be changed to LCP light by first PBP lens 1510. The LCP light may then be changed back to RCP light after passing through switchable half-wave plate 1520. The RCP light may enter second PBP lens 1530. Therefore, the incident light (RCP light beam 1540) may be incident on both first PBP lens 1510 and second PBP lens 1530 as RCP light, and thus the total optical power of liquid crystal device 1500 may be D1+D2.

In FIG. 15B, RCP light beam 1540 is incident on liquid crystal device 1500, where a voltage signal 1550 is applied to switchable half-wave plate 1520 (i.e., switchable half-wave plate 1520 is in the “OFF” state) to turn off switchable half-wave plate 1520 (no polarization state change). RCP light beam 1540 may enter first PBP lens 1510 and may be changed to LCP light by first PBP lens 1510. The LCP light may remain left-handed circularly polarized after passing through switchable half-wave plate 1520 that has been turned off. The LCP light may enter second PBP lens 1530 that has an optical power −D2 for LCP light. Therefore, the total optical power of liquid crystal device 1500 for RCP light beam 1540 may be D1-D2.

Thus, by switching switchable half-wave plate 1520 on or off, the optical power of liquid crystal device 1500 may be switched between D1+D2 and D1−D2. In some embodiments, three or more passive PBP lenses and two or more half-wave plates 1520 may be used in a liquid crystal device to achieve three or more different optical power values and thus three or more different image planes.

### IV. Adaptive Dimming Element

As described above with respect to FIG. 10, a near-eye display device may also include an adaptive dimming element that can change the transmission rate of ambient light. In some embodiments, the adaptive dimming element may include an LC material layer that can be tuned by applying an electrical field to change an orientation of the LC molecules, thus changing the transmission rate of the ambient light. The LC-based adaptive dimming element may be implemented using, for example, a polymer-dispersed liquid crystal light dimming device, a guest-host liquid crystal light dimming device, or a polymer-stabilized cholesteric texture liquid crystal light dimming device. In some implementations, the adaptive dimming element may include an electrochromic device or a photochromic device.

FIG. 16A illustrates an example switchable polymer-dispersed liquid crystal (PDLC) light dimming device 1600 in a “Light OFF” (or opaque) state. FIG. 16B illustrates the example switchable polymer-dispersed liquid crystal light dimming device 1600 in a “Light ON” (or transparent) state. PDLC light dimming device 1600 may include substrates 1610 with coated transparent electrode layers. Substrates 1610 may form a cavity that can hold a PDLC mixture including liquid crystal molecules and polymers. The concentration of polymers in the mixture may be, for example, about 30% to 50%. The polymers may be cured within the LC/polymer emulsion to form a polymer matrix 1620. Droplets 1630 of liquid crystal molecules may be separated by polymer matrix 1620. When a voltage signal is not applied to the transparent electrode layers as shown in FIG. 16A, liquid crystal molecules within each droplet 1630 may have a localized order, but different droplets may be randomly aligned relative to others. Thus, the incident light may be randomly scattered by the liquid crystal molecules and PDLC light dimming device 1600 may be in a “Light OFF” (opaque) state. When a voltage signal is applied to the transparent electrode layers, electro-optic reorientation of liquid crystal droplets 1630 occurs as shown in FIG. 16B, which may reduce the degree of optical scattering through the cell. Thus, PDLC light dimming device 1600 may be in a “Light ON” (transparent) state. In some embodiments, chemical dyes can be added to the PDLC mixtures. The chemical dyes may preferentially scatter or absorb, for example, red, green, or blue light.

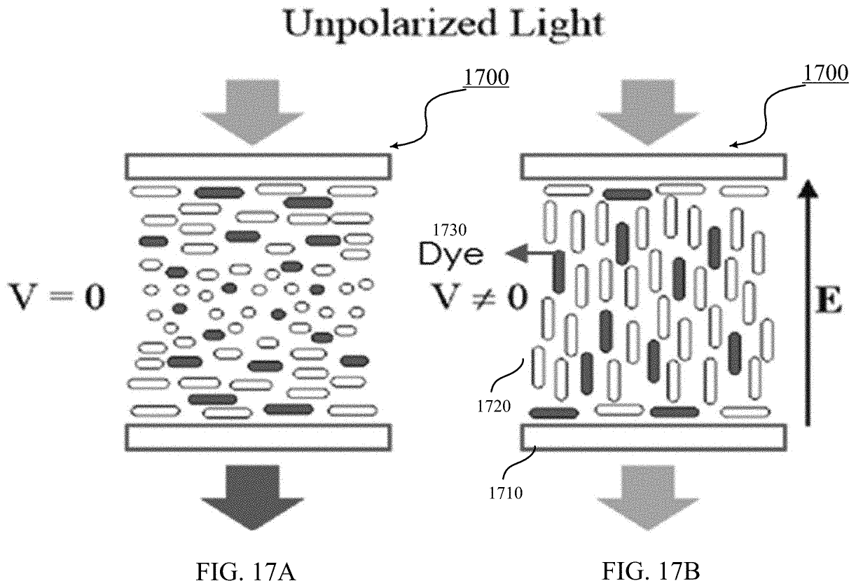

FIG. 17A illustrates an example switchable guest-host liquid crystal light dimming device 1700 in a “Light OFF” (or opaque) state. FIG. 17B illustrates the example switchable guest-host liquid crystal light dimming device 1700 in a “Light ON” (or transparent) state. Guest-host liquid crystal light dimming device 1700 may include two substrates 1710 forming a cavity that holds a mixture including liquid crystal molecules 1720 and dyes 1730 (e.g., dichroic dyes). In some embodiments, the guest-host may be the phase change GH (PC-GH), where, in the “Light OFF” state, the dye is in the cholesteric LC state, and the helix axis of CLC can be parallel or perpendicular to the surface (in both cases, the dye is oriented in all directions due to rotating directors). In some embodiments, the guest-host mode may also be the Heilmeier mode, where a linear polarizer in the front or back of the cell with its transmission axis parallel to the long axis of the dichroic dye molecules or rubbing direction is used. The liquid crystal material may have a positive or negative dielectric anisotropy, and the dichroic dyes may be positive. The liquid crystal molecules may have a homogeneous or twisted nematic alignment.

In the homogeneous alignment case, the liquid crystal molecules and thus the dyes may have a planar alignment when no voltage is applied to guest-host liquid crystal light dimming device 1700. When unpolarized light is incident on guest-host liquid crystal light dimming device 1700, it is linearly polarized by the linear polarizer with a polarization direction aligned with the absorption axis of the dye. Thus, the light may be strongly absorbed by the dyes and the device may show a colored background determined by the dyes used. Therefore, guest-host liquid crystal light dimming device 1700 is in the “Light OFF” (or opaque) state when no voltage is applied. When a voltage is applied to guest-host liquid crystal light dimming device 1700, the LC director may rotate to a homeotropic orientation as shown in FIG. 17B, and thus the absorption due to the dyes decreases because the long absorption axes of the dyes are perpendicular to the direction of polarization of light. Thus, guest-host liquid crystal light dimming device 1700 is in the “Light ON” (or transparent) state when an voltage is applied.

In some embodiments, the liquid crystal light dimming device may include LC with negative dielectric anisotropy, where the LC may have a homeotropic or vertical alignment when no electric field is applied. Thus, the liquid crystal light dimming device may be in the “Light ON” (or transparent) state when no electric field is applied. When an electric field is applied to the liquid crystal light dimming device, LC and dye molecules may reorient to be perpendicular to the electric field (parallel to cell plane), and thus may increase the light absorption by the dye. Therefore, when an electric field is applied, the liquid crystal light dimming device may be in the “Light OFF” (or opaque) state.

In a twisted nematic system, when a voltage is not applied, the helical structure may act as a waveguide and the linearly polarized light may be strongly absorbed as it follows the twisted liquid crystal deformation. Thus, guest-host liquid crystal light dimming device 1700 is in the “Light OFF” (or opaque) state. When a voltage is applied, the helical structure is destroyed, and the absorption decreases as a result of the reorientation of the liquid crystal. Thus, guest-host liquid crystal light dimming device 1700 is in the “Light ON” (or transparent) state.

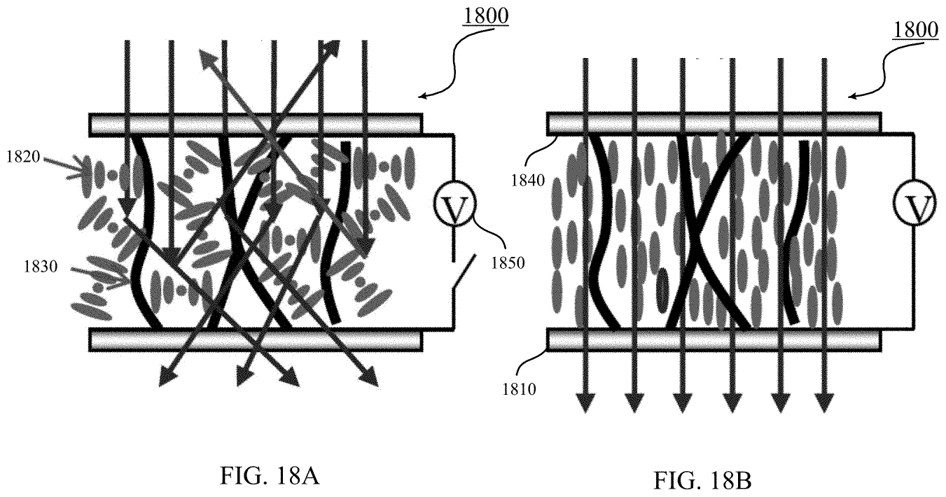

FIG. 18A illustrates an example switchable polymer-stabilized cholesteric texture (PSCT) liquid crystal light dimming device 1800 in a “Light OFF” (or opaque) state. FIG. 18B illustrates the example switchable polymer-stabilized cholesteric texture liquid crystal light dimming device 1800 in a “Light ON” (or transparent) state. PSCT LC light dimming device 1800 may include two substrates 1810 and a mixture of monomers and cholesteric liquid crystals between the two substrates 1810. Polymerization may occur when a high voltage is applied to transparent electrode layers 1840 formed on substrates 1810. The polymerization may tend to unwind the cholesteric structure of the cholesteric texture liquid crystals and reorients the LC molecules to the homeotropic state (perpendicular to the substrate). After polymerization, a liquid crystal cell with a polymer network 1830 perpendicular to substrates 1810 may be formed as shown in FIG. 18A. When a voltage signal 1850 is not applied to transparent electrode layers 1840, the LC molecules may have a helical structure as shown in FIG. 18A, while polymer network 1830 may try to keep the LC director parallel to the polymer network. The competition between these two factors may result in a focal conic texture as shown in FIG. 18A. Thus, the liquid crystal cell may have a poly-domain structure and may be optically scattering (i.e., in the “Light OFF” state). When a sufficiently high electric field is applied across the liquid crystal cell, the LC molecules may be switched to the homeotropic texture as shown in FIG. 18B. Thus, incident light may only see the ordinary reflective index of the LC molecules and may not be scattered. Therefore, the liquid crystal cell is transparent and PSCT LC light dimming device 1800 is in the “Light ON” state. Because the concentration of the polymer may be low and both the LC and the polymer may be aligned in a direction perpendicular to the substrate, the PSCT LC light dimming device may be transparent at a wide range of viewing angles.

It is noted that LC composite materials suitable for light dimming are not limited to the ones described in the above examples. Other LC composite materials having electrically controllable light scattering effect may include, for example, reversed scattering mode PDLCs, LC cells operating in dynamic scattering mode, LC filled with nanoparticles, etc.

### V. Example Method

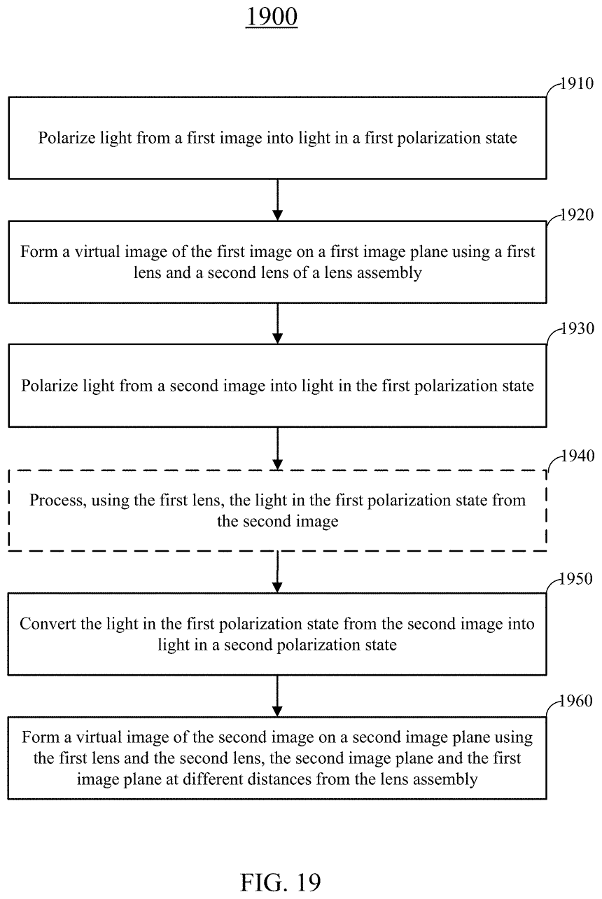

FIG. 19 is a simplified flow chart 1900 illustrating an example method of adaptively displaying images on two or more image planes according to certain embodiments. The operations described in flow chart 1900 are for illustration purposes only and are not intended to be limiting. In various implementations, modifications may be made to flow chart 1900 to add additional operations or to omit some operations. The operations described in flow chart 1900 may be performed using, for example, display optics 124, HMD device 200, near-eye display 300, liquid crystal lens stack 1000, near-eye display device 1100, or near-eye display device 1500.

At block 1910, light from a first image may be polarized into light in a first polarization state using, for example, a linear polarizer or a circular polarizer. The light in the first polarization state may include linearly polarized light with a first polarization direction or left-handed (or right-handed) circularly polarized light.

At block 1920, a virtual image of the first image may be formed on a first image plane using a first lens and a second lens of a lens assembly. The first lens and the second lens may be polarization-dependent. For example, the first lens may have a first non-zero optical power for the light in the first polarization state, while the second lens may have a zero optical power for the light in the first polarization state. Thus, the first non-zero optical power may correspond to the first image plane. In some implementations, the first lens and the second lens are liquid crystal lenses. More detail of the first and second lenses is described above with respect to, for example, FIGS. 10, 12, and 15.

At block 1930, light from a second image may be polarized into light in the first polarization state. As described above with respect to block 1910, the light may be polarized using, for example, a linear polarizer or a circular polarizer. The light first polarization state may include linearly polarized light with a first polarization direction or left-handed (or right-handed) circularly polarized light.

Optionally, at block 1940, the light in the first polarization state from the second image may be first processed by the first lens, which may have the first non-zero optical power for the light in the first polarization state.

At block 1950, the light in the first polarization state from the second image may be converted into light in a second polarization state using, for example, a switchable polarization converter that is in an “ON” state. The switchable polarization converter may transmit the light in the first polarization state without rotation in an “OFF” state. The light in the second polarization state may include linearly polarized light with a second polarization direction or right-handed (or left-handed) circularly polarized light. In some embodiments, the second polarization direction may be orthogonal to the first polarization direction. More detail of the switchable polarization converter is described above with respect to, for example, FIGS. 13-15.

At block 1960, a virtual image of the second image may be formed on a second image plane using the first lens and the second lens. The second image plane and the first image plane are at different distances from the lens assembly. The first lens may have a zero optical power for the light in the second polarization state. The second lens may have a second non-zero optical power for the light in the second polarization state. In some embodiments, the light from the second image, after being polarized to the first polarization state, is processed by the first lens as described above at block 1940 before the light in the first polarization state is converted to the light in the second polarization state. The second lens may process the light in the second polarization state after the light in the first polarization state is converted to the light in the second polarization state. Thus, the overall optical power of the lens assembly for the second image may be a combination of the first non-zero optical power and the second non-zero optical power. In some embodiments, the light from the second image, after being polarized to the first polarization state, may be converted to the light in the second polarization state before being processed by the first lens and the second lens. Because the first lens may have a zero optical power for light in the second polarization state, the overall optical power of the lens assembly for the second image may be the second non-zero optical power. In this way, virtual images may be formed on different image planes by turning on or off the switchable polarization converter.

Embodiments of the invention may be used to implement components of an artificial reality system or may be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

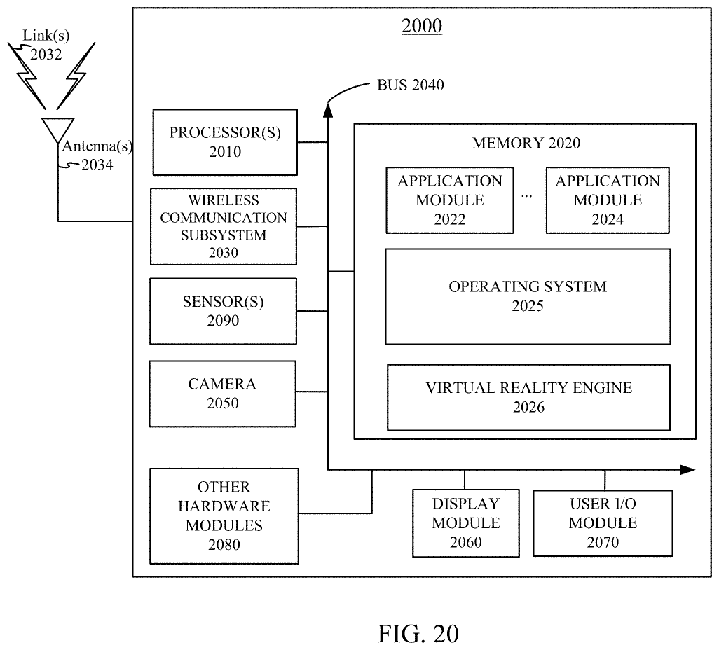

FIG. 20 is a simplified block diagram of an example electronic system 2000 of an example near-eye display (e.g., HMD device) for implementing some of the examples disclosed herein. Electronic system 2000 may be used as the electronic system of an HMD device or other near-eye displays described above. In this example, electronic system 2000 may include one or more processor(s) 2010 and a memory 2020. Processor(s) 2010 may be configured to execute instructions for performing operations at a number of components, and can be, for example, a general-purpose processor or microprocessor suitable for implementation within a portable electronic device. Processor(s) 2010 may be communicatively coupled with a plurality of components within electronic system 2000. To realize this communicative coupling, processor(s) 2010 may communicate with the other illustrated components across a bus 2040. Bus 2040 may be any subsystem adapted to transfer data within electronic system 2000. Bus 2040 may include a plurality of computer buses and additional circuitry to transfer data.

Memory 2020 may be coupled to processor(s) 2010. In some embodiments, memory 2020 may offer both short-term and long-term storage and may be divided into several units. Memory 2020 may be volatile, such as static random access memory (SRAM) and/or dynamic random access memory (DRAM) and/or non-volatile, such as read-only memory (ROM), flash memory, and the like. Furthermore, memory 2020 may include removable storage devices, such as secure digital (SD) cards. Memory 2020 may provide storage of computer-readable instructions, data structures, program modules, and other data for electronic system 2000. In some embodiments, memory 2020 may be distributed into different hardware modules. A set of instructions and/or code might be stored on memory 2020. The instructions might take the form of executable code that may be executable by electronic system 2000, and/or might take the form of source and/or installable code, which, upon compilation and/or installation on electronic system 2000 (e.g., using any of a variety of generally available compilers, installation programs, compression/decompression utilities, etc.), may take the form of executable code.

In some embodiments, memory 2020 may store a plurality of application modules 2022 through 2024, which may include any number of applications. Examples of applications may include gaming applications, conferencing applications, video playback applications, or other suitable applications. The applications may include a depth sensing function or eye tracking function. Application modules 2022-2024 may include particular instructions to be executed by processor(s) 2010. In some embodiments, certain applications or parts of application modules 2022-2024 may be executable by other hardware modules 2080. In certain embodiments, memory 2020 may additionally include secure memory, which may include additional security controls to prevent copying or other unauthorized access to secure information.

In some embodiments, memory 2020 may include an operating system 2025 loaded therein. Operating system 2025 may be operable to initiate the execution of the instructions provided by application modules 2022-2024 and/or manage other hardware modules 2080 as well as interfaces with a wireless communication subsystem 2030 which may include one or more wireless transceivers. Operating system 2025 may be adapted to perform other operations across the components of electronic system 2000 including threading, resource management, data storage control and other similar functionality.

Wireless communication subsystem 2030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2000 may include one or more antennas 2034 for wireless communication as part of wireless communication subsystem 2030 or as a separate component coupled to any portion of the system. Depending on desired functionality, wireless communication subsystem 2030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 2030 may permit data to be exchanged with a network, other computer systems, and/or any other devices described herein. Wireless communication subsystem 2030 may include a means for transmitting or receiving data, such as identifiers of HMD devices, position data, a geographic map, a heat map, photos, or videos, using antenna(s) 2034 and wireless link(s) 2032. Wireless communication subsystem 2030, processor(s) 2010, and memory 2020 may together comprise at least a part of one or more of a means for performing some functions disclosed herein.

Embodiments of electronic system 2000 may also include one or more sensors 2090. Sensor(s) 2090 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 2090 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 2000 may include a display module 2060. Display module 2060 may be a near-eye display, and may graphically present information, such as images, videos, and various instructions, from electronic system 2000 to a user. Such information may be derived from one or more application modules 2022-2024, virtual reality engine 2026, one or more other hardware modules 2080, a combination thereof, or any other suitable means for resolving graphical content for the user (e.g., by operating system 2025). Display module 2060 may use liquid crystal display (LCD) technology, light-emitting diode (LED) technology (including, for example, OLED, ILED, mLED, AMOLED, TOLED, etc.), light emitting polymer display (LPD) technology, or some other display technology.

Electronic system 2000 may include a user input/output module 2070. User input/output module 2070 may allow a user to send action requests to electronic system 2000. An action request may be a request to perform a particular action. For example, an action request may be to start or end an application or to perform a particular action within the application. User input/output module 2070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2000. In some embodiments, user input/output module 2070 may provide haptic feedback to the user in accordance with instructions received from electronic system 2000. For example, the haptic feedback may be provided when an action request is received or has been performed.

Electronic system 2000 may include a camera 2050 that may be used to take photos or videos of a user, for example, for tracking the user's eye position. Camera 2050 may also be used to take photos or videos of the environment, for example, for VR, AR, or MR applications. Camera 2050 may include, for example, a complementary metal-oxide-semiconductor (CMOS) image sensor with a few millions or tens of millions of pixels. In some implementations, camera 2050 may include two or more cameras that may be used to capture 3-D images.

In some embodiments, electronic system 2000 may include a plurality of other hardware modules 2080. Each of other hardware modules 2080 may be a physical module within electronic system 2000. While each of other hardware modules 2080 may be permanently configured as a structure, some of other hardware modules 2080 may be temporarily configured to perform specific functions or temporarily activated. Examples of other hardware modules 2080 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2080 may be implemented in software.

In some embodiments, memory 2020 of electronic system 2000 may also store a virtual reality engine 2026. Virtual reality engine 2026 may execute applications within electronic system 2000 and receive position information, acceleration information, velocity information, predicted future positions, or some combination thereof of the HMD device from the various sensors. In some embodiments, the information received by virtual reality engine 2026 may be used for producing a signal (e.g., display instructions) to display module 2060. For example, if the received information indicates that the user has looked to the left, virtual reality engine 2026 may generate content for the HMD device that mirrors the user's movement in a virtual environment. Additionally, virtual reality engine 2026 may perform an action within an application in response to an action request received from user input/output module 2070 and provide feedback to the user. The provided feedback may be visual, audible, or haptic feedback. In some implementations, processor(s) 2010 may include one or more GPUs that may execute virtual reality engine 2026.

In various implementations, the above-described hardware and modules may be implemented on a single device or on multiple devices that can communicate with one another using wired or wireless connections. For example, in some implementations, some components or modules, such as GPUs, virtual reality engine 2026, and applications (e.g., tracking application), may be implemented on a console separate from the head-mounted display device. In some implementations, one console may be connected to or support more than one HMD.

In alternative configurations, different and/or additional components may be included in electronic system 2000. Similarly, functionality of one or more of the components can be distributed among the components in a manner different from the manner described above. For example, in some embodiments, electronic system 2000 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A near-eye display comprising:
a display device configured to generate a first image and a second image; and
a first assembly of polarization sensitive lenses comprising:
a first lens having different optical powers for light in a first polarization state and light in a second polarization state;
a second lens having different optical powers for light in the first polarization state and light in the second polarization state; and
a switchable polarization converter configured to, after being turned on, convert light in the first polarization state to light in the second polarization state,
wherein the first assembly is configured to:
form, with the switchable polarization converter turned off, a virtual image of the first image on a first image plane of the near-eye display; and
form, with the switchable polarization converter turned on, a virtual image of the second image on a second image plane of the near-eye display, wherein the second image plane and the first image plane are at different distances from the near-eye display.

2. The near-eye display of claim 1, wherein the first lens and the second lens are passive or active liquid crystal lenses.

3. The near-eye display of claim 1, wherein the first assembly is further configured to form a virtual image of a third image generated by the display device on a third image plane of the near-eye display.

4. The near-eye display of claim 1, wherein:
the first polarization state is a first linear polarization state;
the second polarization state is a second linear polarization state with a polarization direction orthogonal to a polarization direction of the first linear polarization state;
the first lens has a first non-zero optical power for light in the first linear polarization state and a zero optical power for light in the second linear polarization state; and
the second lens has a second non-zero optical power for light in the second linear polarization state and a zero optical power for light in the first linear polarization state.

5. The near-eye display of claim 4, wherein the switchable polarization converter includes a switchable liquid crystal half-wave plate.

6. The near-eye display of claim 4, wherein the switchable polarization converter includes a switchable liquid crystal polarization rotator including a 90° twisted nematic liquid crystal cell.

7. The near-eye display of claim 4, wherein:
the switchable polarization converter is positioned between the display device and the first lens;
the first image plane corresponds to the first non-zero optical power; and
the second image plane corresponds to the second non-zero optical power.

8. The near-eye display of claim 4, wherein:
the switchable polarization converter is positioned between the first lens and the second lens;
the first image plane corresponds to the first non-zero optical power; and
the second image plane corresponds to a combination of the first non-zero optical power and the second non-zero optical power.

9. The near-eye display of claim 1, wherein:
the first polarization state is a first circular polarization state;
the second polarization state is a second circular polarization state having a handedness opposite to a handedness of the first circular polarization state;
the first lens has an optical power X for light in the first circular polarization state and an optical power −X for light in the second circular polarization state;
the second lens has an optical power Y for light in the first circular polarization state and an optical power −Y for light in the second circular polarization state; and
the switchable polarization converter includes a switchable half-wave plate.

10. The near-eye display of claim 9, wherein the switchable polarization converter is positioned between the first lens and the second lens.

11. The near-eye display of claim 1, wherein the first assembly further comprises a polarizer configured to polarize light from the first image and the second image into light in the first polarization state.

12. The near-eye display of claim 1, further comprising a second assembly of polarization sensitive lenses, wherein the second assembly has opposite optical power compared with the first assembly.

13. The near-eye display of claim 12, wherein the second assembly comprises:
a third polarization sensitive lens having an optical power opposite to an optical power of the first lens for light in the first polarization state;
a fourth polarization sensitive lens having an optical power opposite to an optical power of the second lens for light in the second polarization state; and
a second switchable polarization converter configure to, after being turned on, convert light in the first polarization state to light in the second polarization state.

14. The near-eye display of claim 1, further comprising a dimming device switchable between a first state and a second state, wherein the dimming device is configured to:
transmit ambient light in the first state; and
attenuate the ambient light in the second state.

15. The near-eye display of claim 14, wherein the dimming device includes:
a guest-host liquid crystal light dimming element;
a polymer-dispersed liquid crystal light dimming element; or
a polymer-stabilized cholesteric texture liquid crystal light dimming element.

16. A lens assembly for near-eye display, the lens assembly comprising:
a first polarization-dependent lens having a first non-zero optical power for light in a first polarization state;
a second polarization-dependent lens having a second non-zero optical power for light in a second polarization state that is different from the first polarization state; and
a polarization converter switchable between a first state and a second state, wherein the polarization converter is configured to:
transmit, in the first state, light in the first polarization state; and
convert, in the second state, light in the first polarization state to light in the second polarization state.

17. The lens assembly of claim 16, wherein:
the polarization converter includes a 90° twisted nematic liquid crystal cell; and
the polarization converter is switchable between the first state and the second state based on a voltage signal applied to the 90° twisted nematic liquid crystal cell.

18. The lens assembly of claim 16, wherein the first polarization-dependent lens and the second polarization-dependent lens include a passive or active liquid crystal lens.

19. The lens assembly of claim 18, wherein the liquid crystal lens includes:
a plane-convex liquid crystal lens;
a flat liquid crystal lens including tilted liquid crystal molecules, wherein the liquid crystal molecules are tilted at different angles at different areas of the flat liquid crystal lens;
a diffractive liquid crystal lens including a plurality of zones, wherein liquid crystal molecules in the plurality of zones are tilted at different angles; or
a geometric-phase liquid crystal lens.

20. The lens assembly of claim 16, wherein the first polarization-dependent lens and the second polarization-dependent lens are positioned on a same side of the polarization converter or on different sides of the polarization converter.

21. The lens assembly of claim 16, wherein the first polarization state and the second polarization state include:
linear polarizations at orthogonal polarization directions; or
left-handed circular polarization and right-handed circular polarization.

22. The lens assembly of claim 16, further comprising a polarizer configured to polarize incident light into light in the first polarization state, wherein the first polarization-dependent lens, the second polarization-dependent lens, and the polarization converter are positioned on a same side of the polarizer.

23. A method of adaptively displaying images on two or more image planes using a lens assembly, the method comprising:
polarizing light from a first image into light in a first polarization state;
forming a virtual image of the first image on a first image plane using a first lens and a second lens of the lens assembly, the first lens having different optical powers for light in the first polarization state and light in a second polarization state, and the second lens having different optical powers for light in the first polarization state and light in the second polarization state;
polarizing light from a second image into light in the first polarization state; and
forming a virtual image of the second image on a second image plane using the first lens and the second lens, the second image plane and the first image plane at different distances from the lens assembly, wherein forming the virtual image of the second image on the second image plane comprises:
converting, using a switchable polarization converter in the lens assembly, the light in the first polarization state from the second image into light in the second polarization state.
